(19) United States
(12) Patent Application Publication
(10) Pub. No.: US 2026/0181883 A1
(43) Pub. Date: Jun. 25, 2026

(54) SEMICONDUCTOR MEMORY DEVICES WITH BACKSIDE TRANSISTORS

(71) Applicant: Taiwan Semiconductor Manufacturing Company, Ltd., Hsinchu (TW)

(72) Inventor: Meng-Sheng Chang, Hsinchu (TW)

(73) Assignee: Taiwan Semiconductor Manufacturing Company, Ltd., Hsinchu (TW)

(21) Appl. No.: 19/170,946

(22) Filed: Apr. 4, 2025

Related U.S. Application Data
(60) Provisional application No. 63/738,049, filed on Dec. 23, 2024.

(51) Int. Cl. H10B 20/25; G11C 17/16; G11C 17/18

(52) U.S. Cl. CPC H10B 20/25; G11C 17/16; G11C 17/18

(57) ABSTRACT

A memory device includes a substrate and a memory cell. The substrate includes a frontside and a backside opposite to the frontside. The memory cell includes a programming transistor, a reading transistor, and a backside via. The programming transistor is disposed on a first one of the frontside or the backside of the substrate. The reading transistor is disposed a second one of the frontside or the backside of the substrate opposite to the programming transistor. The backside via extends from the backside to the frontside of the substrate, thereby coupling the programming transistor to the reading transistor in series.

### CROSS-REFERENCE TO RELATED APPLICATION

This application claims priority to and the benefit of U.S. Provisional Application No. 63/738,049, filed Dec. 23, 2024, the disclosure of which is incorporated herein by reference in its entirety for all purposes.

### BACKGROUND

Integrated circuits (ICs) sometimes include one-time-programmable (OTP) memories to provide non-volatile memory (NVM) in which data is not lost when the IC is powered off. One type of the OTP devices includes anti-fuse memories. The anti-fuse memories include a number of anti-fuse memory cells (or bit cells), whose terminals are disconnected before programming, and are shorted (e.g., connected) after the programming. The anti-fuse memories may be based on metal-oxide-semiconductor (MOS) technology. For example, an anti-fuse memory cell may include a programming MOS transistor (or MOS capacitor) and at least one reading MOS transistor coupled in series. A gate dielectric of the programming MOS transistor may be broken down to cause the gate and the source/drain of the programming MOS transistor to be interconnected. Depending on whether the gate dielectric of the programming MOS transistor is broken down, different data bits can be presented by the anti-fuse memory cell through reading a resultant current flowing through the programming MOS transistor and reading MOS transistor. The anti-fuse memories have the advantage of reverse-engineering proofing since the programming states of the anti-fuse cells cannot be determined through reverse engineering.

### BRIEF DESCRIPTION OF THE DRAWINGS

Aspects of the present disclosure are best understood from the following detailed description when read with the accompanying figures. It is noted that in accordance with the standard practice in the industry, various features are not drawn to scale. In fact, the dimensions of the various features may be arbitrarily increased or reduced for clarity of discussion.

FIG. 1A illustrates a block diagram of an example memory system in accordance with some embodiments.

FIG. 1B illustrates an example circuit diagram of a portion of a memory array of the memory system of FIG. 1A in accordance with some embodiments.

FIG. 2A illustrates an example circuit diagram of a memory cell of the memory array of FIGS. 1A-1B in accordance with some embodiments.

FIG. 2B illustrates another example circuit diagram of the memory cell of the memory array of FIG. 2A in accordance with some embodiments.

FIG. 2C illustrates an example circuit diagram of a memory cell of the memory array of FIG. 1A in accordance with other embodiments.

FIG. 3 illustrates a flow chart of an example method of operating the memory system of FIG. 1A in accordance with some embodiments.

FIGS. 4A and 4B each illustrate a cross-sectional view of a memory device including a memory cell of FIGS. 2A-2B in accordance with some embodiments.

FIG. 5 illustrates a 2D access transistor in accordance with some embodiments.

FIG. 6 illustrates a cross-sectional view of a memory device including a memory cell of FIG. 2C in accordance with some embodiments.

FIGS. 7A and 7B each illustrate various example circuit diagrams of a memory cell of the memory array of FIG. 1A in accordance with other embodiments.

FIGS. 8A, 8B, and 8C illustrate various cross-sectional views of the memory devices formed based on circuit diagrams of FIGS. 7A and 7B in accordance with some embodiments.

FIG. 9 illustrates a 3D access transistor in accordance with some embodiments.

FIG. 10 illustrates a flow chart of a method of fabricating, in portion or in entirety, a memory device including a memory cell of any of FIGS. 2A-9 in accordance with some embodiments.

FIG. 11 illustrates a flow chart of a method of fabricating a portion of a memory cell of any of FIGS. 2A-9 in accordance with some embodiments.

FIG. 12 illustrates a flow chart of a method of fabricating a portion of a memory cell of any of FIGS. 2A-9 in accordance with some embodiments.

FIGS. 13A, 13B, 13C, 13D, 13E, 13F, 13G, and 13H illustrate various cross-sectional views of a memory device during intermediate stages of the method as shown in FIG. 12 in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A physically unclonable function (PUF) is generally used for authentication and secret key storage without requiring secure electrically erasable programmable read-only memory (EEPROMs) and/or other expensive hardware (e.g., battery-backed static random-access memory). Instead of storing secrets in a digital memory, the PUF derives secret information from physical characteristics of an integrated circuit (IC). The PUF is based on an idea that even though an identical manufacturing process is used to fabricate a number of ICs, each IC may be slightly different from one another due to manufacturing variability. PUFs leverage this variability to derive “secret” information that is unique to each of the ICs (e.g., a silicon biometric). Generally, such secret information is referred to as a “PUF signature” of the IC. In addition, due to the manufacturing variability that defines the PUF signature, one cannot manufacture two identical ICs even with full knowledge of the IC's design. Different types of manufacturing variability of an IC can be used to define such a signature.

Embodiments of the present disclosure provide various systems and methods to generate and read at least a bit of a PUF signature (alternatively referred to as a PUF bit) for/from a memory device that includes a number of memory cells. In some embodiments, each of the memory cells is implemented as an anti-fuse cell that includes a first programming transistor, a second programming transistor, a first reading transistor, and a second reading transistor, where the first programming transistor and the first reading transistor are coupled in series, and the second programming transistor and the second reading transistor are coupled in series. Even though the first and the second programming transistors are formed in the same dimensions and the same material, while being concurrently with the same level of a programming voltage, one of the first and the second programming transistors can precede the other to be broken down by the programming voltage, according to various embodiments. Upon one of the first and the second programming transistors being broken down, the programming process may stop. As such, one of the two programming transistors can be randomly programmed. Based on which of the two programming transistors is broken down first, the disclosed system generates at least one PUF bit for/from the memory device. Applying the same principle over all of the memory cells, the disclosed system can generate a unique PUF signature for/from the memory device.

In some embodiments, at least one of the transistors in a memory cell (e.g., at least one of the programming transistors and/or at least one of the reading transistors) of a memory device is formed along a major surface of a backside (hereafter referred to as “on the backside” for simplicity) of a substrate of the memory device (i.e., as a part of a backside network of the memory device). In some embodiments, at least one of the transistors in the memory cell is formed on the backside and at least one of the remaining transistors in the memory cell is formed along a major surface of a frontside (hereafter referred to as “on the frontside” for simplicity) of the substrate, such as in a front-end-of-line (FEOL) network, opposite to the backside. In this regard, the transistor(s) disposed on the backside of the substrate are physically, electrically, or operatively coupled (hereafter referred simply as “coupled”) to backside metal tracks, which are embedded in backside metallization layers. Such an arrangement involving backside transistors provides at least the benefit of reduced area per memory cell on the frontside of the substrate, leading to improved cell density and reduced programming voltage.

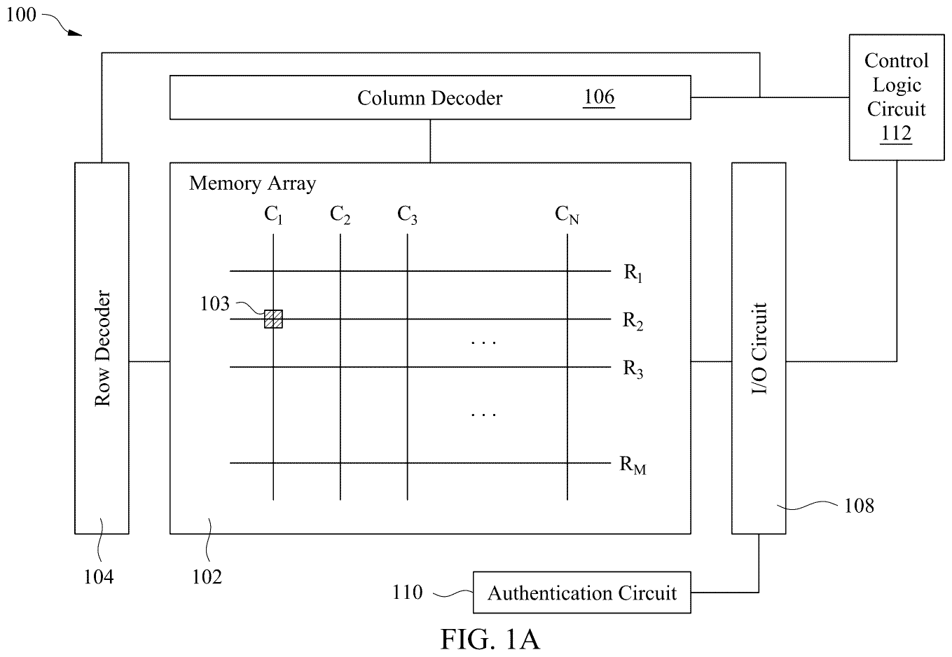

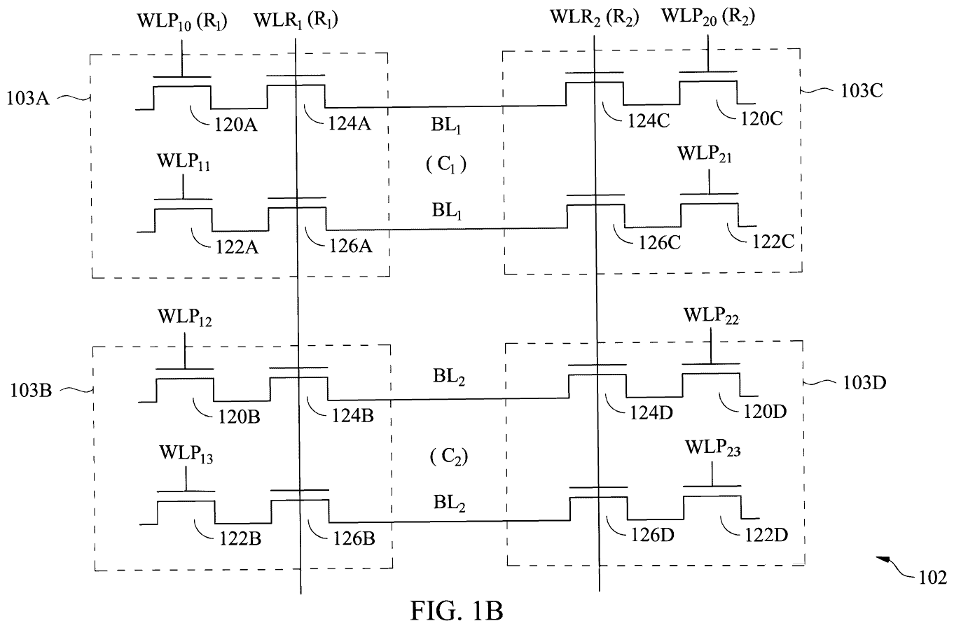

FIG. 1A illustrates a memory system 100 (alternatively referred to as memory cell 100) in accordance with various embodiments. In the illustrated embodiment of FIG. 1A, the memory system 100 includes a memory array 102, a row decoder 104, a column decoder 106, an input/output (I/O) circuit 108, an authentication circuit 110, and a control logic circuit 112. Despite not being shown in FIG. 1A, all of the components of the memory system 100 may be coupled to each other and to the control logic circuit 112. Although, in the illustrated embodiment of FIG. 1A, each component is shown as a separate block for the purpose of clear illustration, in other embodiments, some or all of the components shown in FIG. 1A may be integrated together. For example, the memory array 102 may include an embedded authentication circuit (e.g., 110).

The memory array 102 includes a hardware component that stores data. In one aspect, the memory array 102 is implemented as a semiconductor memory device. The memory array 102 includes a plurality of memory cells 103 (alternatively referred to as storage units 103). The memory array 102 includes a number of rows R₁, R₂, R₃ . . . R_{M}, each extending in a first lateral direction (e.g., X-direction) and a number of columns C₁, C₂, C₃ . . . C_{N}, each extending in a second lateral direction (e.g., Y-direction) perpendicular to the first direction. Each of the rows/columns may include one or more conductive structures function as access lines. In some embodiments, each memory cell 103 is arranged in the intersection of a corresponding row and a corresponding column, and can be operated according to voltages or currents through the respective conductive structures of the column and row.

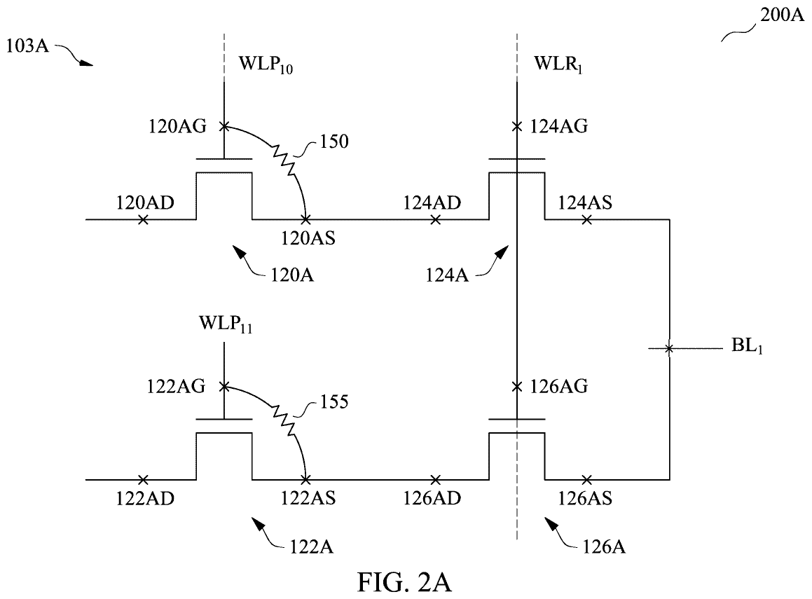

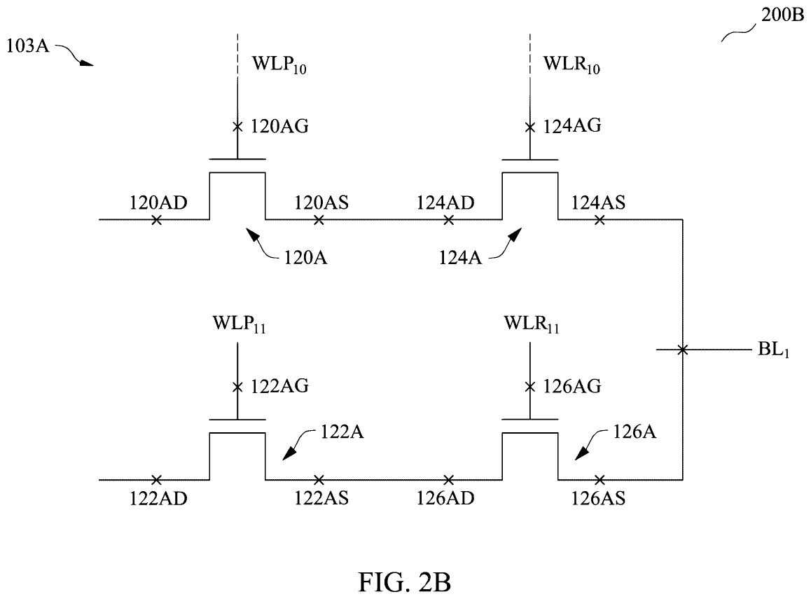

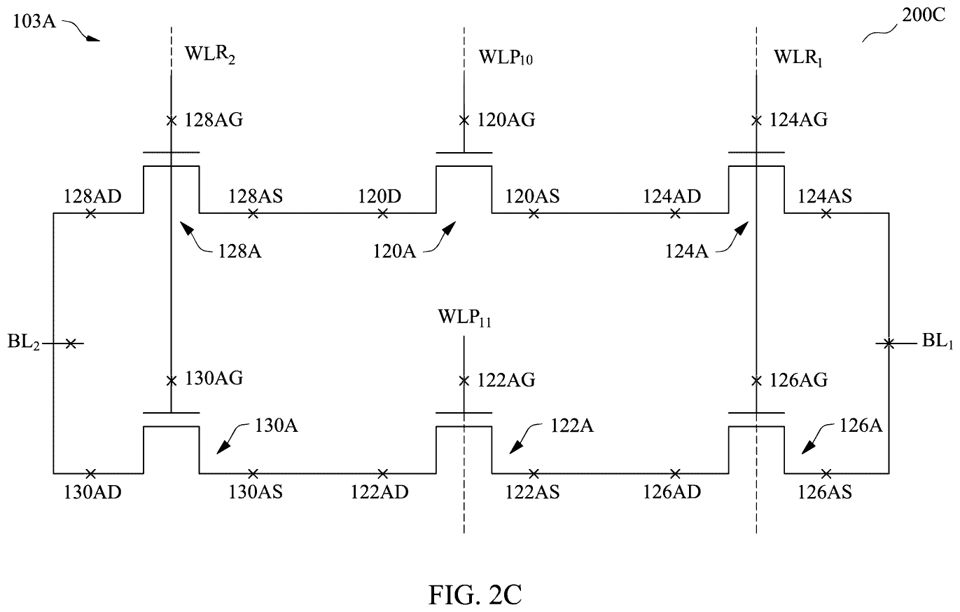

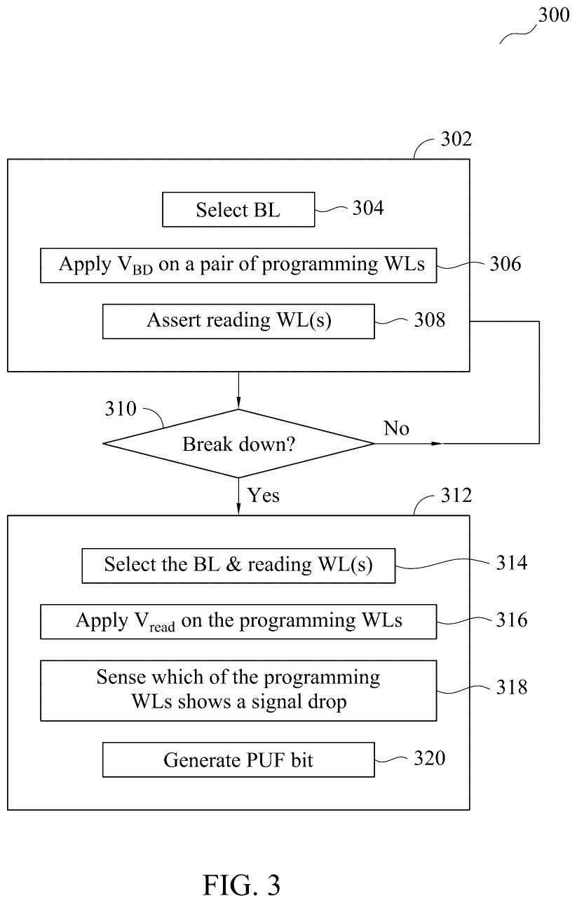

In some embodiments, each memory cell 103 is implemented as an anti-fuse memory cell including a first programming transistor, a second programming transistor, a first reading transistor, and a second reading transistor. The first programming transistor and the first reading transistor are coupled in series, and the second programming and the second reading transistors are coupled in series. The first and the second reading transistors can be concurrently or respectively turned on/off to enable/disable an access (e.g., program or read) to the respective first and second programming transistors. For example, upon being enabled, the two programming transistors can be programmed at the same time (e.g., by commonly applying a programming voltage). Randomly, one of the programming transistors can be broken down faster than the other, and thus a logic state of the memory cell can be determined based on which of the two programming transistors has been broken down. Such randomly determined logic states of the memory cells can constitute the basis of a PUF signature. Detailed descriptions on configurations and operations of the memory cell 103 to generate a PUF signature will be discussed below with respect to FIGS. 2A-2C and 3.

The row decoder 104 includes a hardware component that can receive a row address of the memory array 102 and assert a conductive structure (e.g., a word line) at that row address. The column decoder 106 includes a hardware component that can receive a column address of the memory array 102 and assert one or more conductive structures (e.g., a pair of source lines) at that column address. The I/O circuit 108 includes a hardware component that can access (e.g., read or program) each of the memory cells 103 asserted through the row decoder 104 and column decoder 106. The authentication circuit 110 includes a hardware component that can generate a PUF signature based on respective logic states of the memory cells read by the I/O circuit 108. The control logic circuit 112 includes a hardware component that can control the coupled components (e.g., 102 through 110).

FIG. 1B illustrates an example circuit diagram of a portion of the memory system 100 (e.g., some memory cells 103) in accordance with some embodiments. In the illustrated example of FIG. 1B, memory cells 103A, 103B, 103C and 103D of the memory array 102, configured as anti-fuse cells described above, are shown. It should be appreciated that the memory array 102 can have any number of the cells 103 while remaining within the scope of present disclosure.

As mentioned above, the memory cells 103 can be arranged as an array. As shown in FIG. 1B, the memory cells 103A and 103B may be disposed in a same row but in respectively different columns; and the memory cells 103C and 103D may be disposed in a same row but in respectively different columns. For example, the memory cells 103A and 103B are disposed in the same row R₁, but in different columns C₁ and C₂, respectively; and the memory cells 103C and 103D are disposed in the same row R₂, but in different columns C₁ and C₂, respectively. With such a configuration, each of the memory cells can be operatively coupled to the access lines in the corresponding row and column, respectively.

For example, referring to FIG. 1B, the memory cell 103A is operatively coupled to a first programming word line, a second programming word line, and a reading word line in row R₁ (hereinafter referred to as WLP₁₀, WLP₁₁, and WLR₁, respectively) and to a bit line in column C₁ (hereinafter referred to as BL₁); the memory cell 103B is operatively coupled to a third programming word line (hereinafter referred to as WLP₁₂), a fourth programming word line (hereinafter referred to as WLP₁₃), and the reading word line WLR₁ in row R₁ and to a bit line in column C₂ (hereinafter referred to as BL₂); the memory cell 103C is operatively coupled to a first programming word line, a second programming word line, and a reading word line in row R₂ (hereinafter referred to as WLP₂₀, WLP₂₁, and WLR₂, respectively) and to the bit line BL₁ in column C₁; and the memory cell 103D is operatively coupled to a third programming word line (hereinafter referred to as WLP₂₂), a fourth programming word line (hereinafter referred to as WLP₂₃), and the reading word line WLR₂ in row R₂ and to the bit line BL₂ in column C₂.

In some embodiments, the memory cells 103A through 103D can be operatively coupled to the I/O circuit 108 through their respective WLR, WLP, and BL for being accessed (e.g., programmed or reading). For example, the I/O circuit 108 can cause the row decoder 104 to assert the WLP₁₀, WLP₁₁, and WLR₁ and the column decoder 106 to assert the BL₁, so as to access the memory cell 103A. Accordingly, each of the memory cells 103A-D can be individually selected to be programmed. Details about programming and reading the memory cell will be discussed in further detail below.

Each of the memory cells 103A through 103D includes a plurality of programming transistors and a plurality of reading transistors, where each of the programming transistors is coupled to a corresponding one of the reading transistors in series. Further, the programming transistors are separately gated, while the reading transistors may or may not be commonly gated in accordance with various embodiments. In some embodiments, as shown in FIG. 1B, the reading transistors disposed along the same row are commonly gated. The memory cell 103A is selected as a representative example in the following discussions.

As shown in FIG. 1B, the memory cell 103A includes two programming transistors 120A and 122A, and two reading transistors 124A and 126A. The programming transistor 120A is coupled to the reading transistor 124A in series; and the programming transistor 122A is coupled to the reading transistor 126A in series. One source/drain terminal of each of the programming transistors 120A and 122A is floating (i.e., not connected to any other functioning features); and the other source/drain terminal of each of the programming transistors 120A and 122A is serially coupled to one source/drain terminal of the corresponding reading transistor 124A/126A, with the other source/drain terminals of the reading transistors 124A and 126A commonly coupled to the BL₁.

Specifically, the programming transistor 120A is gated by the WLP₁₀ (i.e., a gate terminal of the programming transistor 120A is coupled to the WLP₁₀), and the programming transistor 122A is gated by the WLP₁₁ (i.e., a gate terminal of the programming transistor 122A is coupled to the WLP₁₁). The reading transistors 124A and 126A are both gated by the WLR₁ (i.e., both gate terminals of the reading transistors 124A and 126A are coupled to the WLR₁). However, it should be understood that the gate terminals of the reading transistors 124A and 126A may be coupled to different WLRs. In some embodiments, the gate terminals (formed as gate structures as discussed below) of the programming transistors 120A and 122A may be isolated from each other by forming a dielectric structure interposed between the gate structures (not shown herein).

Each of other memory cells (e.g., 103B, 103C, and 103D) is configured substantially the same as the memory cell 103A, and thus the memory cells 103B-103D are only briefly described as follows. The memory cell 103B includes programming transistors 120B and 122B gated by WLP₁₂ and WLP₁₃ respectively, and the reading transistors 124B and 126B gated by WLR₁; the memory cell 103C includes programming transistors 120C and 122C gated by WLP₂₀ and WLP₂₁ respectively, and the reading transistors 124C and 126C gated by WLR₂; and the memory cell 103D includes programming transistors 120D and 122D gated by WLP₂₂ and WLP₂₃ respectively, and the reading transistors 124D and 126D gated by WLR₂.

Referring to FIG. 2A, provided is an example circuit diagram 200A of the memory cell 103A to illustrate operations of each of the memory cells 103 according to some embodiments. As shown, each of the programming/reading transistors 120A-126A may include an n-type metal-oxide-semiconductor field-effect-transistor (n-type MOSFET) or referred to as an NMOS transistor. However, it should be understood that each of the programming/reading transistors 120A-126A may alternatively include a p-type metal-oxide-semiconductor field-effect-transistor (p-type MOSFET) while remaining within the scope of present disclosure.

Specifically, the programming transistors 120A and 122A have their drain terminals 120AD and 122AD floating (e.g., disconnected from any functional circuit component), and their source terminals 120AS and 122AS coupled to drain terminals 124AD and 126AD of the reading transistors 124A and 126A, respectively. Source terminals 124AS and 126AS of the reading transistors 124A and 126A are commonly coupled to the BL₁. The programming transistor 120A has its gate terminal 120AG coupled to the WLP₁₀, and the programming transistor 122A has its gate terminal 122AG coupled to the WLP₁₁. On the other hand, the reading transistors 124A and 126A have their gate terminals 124AG and 126AG commonly coupled to the WLR₁ and are said to be commonly gated.

To program the memory cell 103A, the reading transistors 124A and 126A are turned on by supplying a high enough voltage (e.g., a positive voltage corresponding to a logic high state) to their gate terminals 124AG and 126AG via the WLR₁. Prior to, concurrently with, or subsequently to the reading transistors 124A and 126A being turned on, a high enough voltage (e.g., a breakdown voltage (V_{BD}), referred to as a programming voltage) is concurrently applied to the WLP₁₀ and WLP₁₁, and a low enough voltage (e.g., a positive voltage or ground voltage corresponding to a logic low state) is applied to the BL₁. The low enough voltage (applied on the BL₁) can be passed to the source terminal 120AS and 122AS. As such, that V_{BD} can be concurrently present across the source terminal 120AS and the gate terminal 120AG of the programming transistor 120A and across the source terminal 122AS and the gate terminal 122AG of the programming transistor 122A.

Due to processing variability, even though these two programming transistors 120A and 122A are formed of substantially the same materials (e.g., the same dielectric film) and made in substantially identical dimensions, one of the two programming transistors should be broken down faster than the other programming transistors. Specifically, either a portion of a gate dielectric layer (e.g., the portion between the source terminal 120AS and the gate terminal 120AG) of the programming transistor 120A or a portion of a gate dielectric layer (e.g., the portion between the source terminal 122AS and the gate terminal 122AG) of the programming transistor 122A will be precedingly broken down. As the gate terminal 120AG of the programming transistor 120A and the gate terminal 122AG of the programming transistor 122A are isolated from each other, such a preceding breakdown can randomly and individually occur. After the gate dielectric layer of the programming transistor 120A or 122A is broken down, a behavior of the portion of the gate dielectric layer interconnecting the gate terminal 120AG/122AG and the source terminal 120AS/122AS is equivalently resistive. For example, such a portion of the gate dielectric layer of the programming transistor 120A (if broken down first) may function as a resistor 150, while such a portion of the gate dielectric layer of the programming transistor 122A (if broken down first) may function as a resistor 155, as shown in FIG. 2A. Before the programming occurs (e.g., before the gate dielectric layer of either of the programming transistors 120A or 122A is broken down), no conduction path exists between the BL₁ and any of the WLP₁₀ and WLP₁₁, even if the reading transistors 124A and 126A are turned on. After the programming, a conduction path exists either between the BL₁ and the WLP₁₀ (e.g., via the resistor 150) or between the BL₁ and the WLP₁₁ (e.g., via the resistor 155), when the reading transistors 124A and 126A are turned on.

Upon a breakdown occurring to one of the programming transistors 120A and 122A, a conduction path is established. In an example where the programming transistor 120A is broken down first, a sudden increase of voltage can be present on the source terminal 120AS, which can induce a sudden increase of voltage on BL₁. Accordingly, a voltage level at the source terminal 122AS of the programming transistor 122A can be increased such that the programming process on the transistor 122A can be automatically stopped (as a voltage drop across its gate and source terminals is decreased). Consequently, the memory cell 103A can be “randomly” programmed to a first logic state or a second logic state. Whether the first or second logic state is programmed into the memory cell can correspond to which of the programming transistors is broken down (first), which may be determined based on a further reading process.

In some embodiments, the reading process includes concurrently applying a relatively low level of a voltage (referred to as a reading voltage) on these two programming transistors, an observable decrease of reading voltage may be present on the broken-down programming transistor, while the reading voltage applied on the non-broken-down programming transistor may remain substantially unchanged. In the above example where the programming transistor 120A is broken down (while the programming transistor 122A remains intact), the reading voltage applied on WLP₁₀ may be observed as lower than the reading voltage applied on WLP₁₁. As such, a logic state of the cell 103A (a PUF bit) can be determined accordingly. Based on such a randomly programmed logic state on each of the memory cells, a PUF signature (formed of various PUF bits of the memory cells) can be generated.

FIG. 2B illustrates another example circuit diagram 200B of the memory cell 103A in accordance with some embodiments. The circuit diagram of FIG. 2B is substantially similar to the circuit diagram of FIG. 2A except that the two reading transistors 124A and 126A are gated by respective different WLR₁₀ and WLR₁₁. Thus, the discussions will not be repeated for purposes of brevity.

FIG. 2C illustrates yet another example circuit diagram 200C of the memory cell 103A in accordance with some embodiments. The circuit diagram of FIG. 2C is substantially similar to the circuit diagram of FIG. 2A except that two additional reading transistors 128A and 130A are serially coupled to the programming transistors 120A and 122A as well as the reading transistors 124A and 126A, respectively. With such two additional reading transistors 128A and 130A, a read margin of the memory cell 103A may be improved. As shown, drain terminals 128A and 130A of the reading transistors 128A and 130A are coupled to the BL₂, and source terminals 128AS and 130AS of the reading transistors 128A and 130A are coupled to the drain terminals 120AD and 122AD, respectively. Source terminals of the reading transistors 124A and 126A are commonly coupled to the BL₁. The reading transistors 128A and 130A have their gate terminals 128AG and 130AG commonly coupled to another reading word line WLR₂. However, it should be understood that the gate terminals 128AG and 130AG can be coupled to respective different reading word lines, while remaining within the scope of present disclosure.

FIG. 3 illustrates an example flow chart of a method 300 of generating a PUF signature based on an anti-fuse memory cell including a pair of programming transistors and a pair of reading transistors in accordance with various embodiments. For purposes of discussion, the following embodiment of the method 300 will be described in conjunction with FIGS. 1A-2C (e.g., the memory cell 103A of any of FIGS. 2A-2C). The illustrated embodiment of the method 300 is merely an example so that any of a variety of operations may be omitted, re-sequenced, and/or added, while remaining within the scope of the present disclosure.

The method 300 starts at operation 302 of a programing process. Specifically, operation 302 includes operation 304 during which a bit line is selected, operation 306 during which a pair of programming word lines are concurrently applied with a high programming voltage (e.g., V_{BD}), and operation 308 during which one or more reading word lines are asserted. It should be noted the sequence of operations 304-308 can be changed while remaining within the scope of present disclosure. For example, operation 308 may be performed prior to operations 304 and 306.

Also referring to FIGS. 1A and 2A, the control logic circuit 112 can provide a column address for the column decoder 106 to select one of the columns C₁ to C_{N} of the memory array 102 at operation 304. Upon selecting a column, the I/O circuit 108 can provide a voltage (e.g., a logic low voltage) to a BL arranged in the selected column, e.g., BL₁ in FIG. 2A. In some embodiments, the selected BL₁ may be pulled to ground. Next, the control logic circuit 112 can provide a row address for the row decoder 104 to select one of the rows R₁ to R_{M} of the memory array 102. Upon selecting a row, the I/O circuit 108 can provide the programming voltage (V_{BD}) to a pair of programming word lines arranged in the selected row (e.g., WLP₁₀ and WLP₁₁ of FIG. 2A) at operation 306, and the I/O circuit 108 can provide a voltage (e.g., a voltage corresponding to a logic high state) to a reading word line arranged in the selected row (e.g., WLR₁ of FIG. 2A) at operation 308, thereby turning on the reading transistors 124A and 126A. As such, the memory cell (e.g., the memory cell 103A) arranged in the intersection of the selected column and row can be programmed.

Next, the method 300 proceeds to operation 310 to determine whether or not one of the programming transistors of the selected memory cell has been broken down (i.e., programmed). If so, the method 300 proceeds to operation 312 that includes one or more reading processes; and if not, the method 300 returns to operation 302 to perform the programing process again. In various embodiments, the I/O circuit 108 can determine whether the breakdown occurs to one of the programming transistors based on detecting a voltage increase present on the selected BL (e.g., BL₁), as discussed above.

Operation 312 further includes operation 314 during which the bit line and the reading word line are selected or asserted, operation 316 during which the pair of programming word lines are concurrently applied with a relatively low reading voltage (V_{read}), operation 318 to sense which of the programming word lines shows a signal decrease, and operation 320 during which a PUF bit is generated.

Referring first to operation 314, the control logic circuit 112 can provide a column address for the column decoder 106 to select one of the columns C₁ to C_{N} of the memory array 102 and provide a row address for the row decoder 104 to select one of the rows R₁ to R_{M} of the memory array 102. In some embodiments, the column and row asserted during operation 314 is the same as the column asserted during operation 304 and the row asserted in operation 308, respectively. As a result, BL₁ is again pulled to ground, and the reading transistors 124A and 126A are again turned on.

Referring next to operation 316, based on the selected row, the I/O circuit 108 can provide the V_{read} to the programming word lines arranged in the selected row (e.g., both of WLP₁₀ and WLP₁₁ of FIG. 2A). Thus, the memory cell 103A can be read. Next in operation 318, the I/O circuit 108 can sense which of the WLP₁₀ and WLP₁₁, both connected or coupled to the memory cell 103A, shows a signal drop as discussed above.

Consequently, the control logic circuit 112 can determine the logic state programmed into the memory cell 103A based on whether it is WLP₁₀ and WLP₁₁ that has the signal drop and provide such a logic state to the authentication circuit 110 to generate a PUF bit (operation 320). If the signal drop is present on WLP₁₀ (i.e., the programming transistor 120A has been broken down), the control logic circuit 112 can determine that a first logic state has been programmed into the memory cell 103A. If the signal drop is present on WLP₁₁ (i.e., the programming transistor 122A has been broken down), the control logic circuit 112 can determine that a second logic state has been programmed into the memory cell 103A.

The present disclosure provides various embodiments of memory cells 105 (e.g., 105A-105F described below corresponding to the memory cells 103A or 103B of FIGS. 2A-2C) each including at least one transistor (programming or reading) formed as a part of a backside network (e.g., a backside power delivery network or BSPDN) of the memory cell 105, while the remaining transistors are formed as a part of a frontside network (e.g., a FEOL network) of the memory cell 105. Accordingly, in some embodiments, at least one transistor of the memory cell 105 is formed on a backside of a substrate. In some embodiments, in addition to the transistor on the backside, the memory cell 105 includes at least one transistor on a frontside of the substrate opposite to the backside. In some embodiments, all of the transistors of the memory cell are formed on the backside of the substrate.

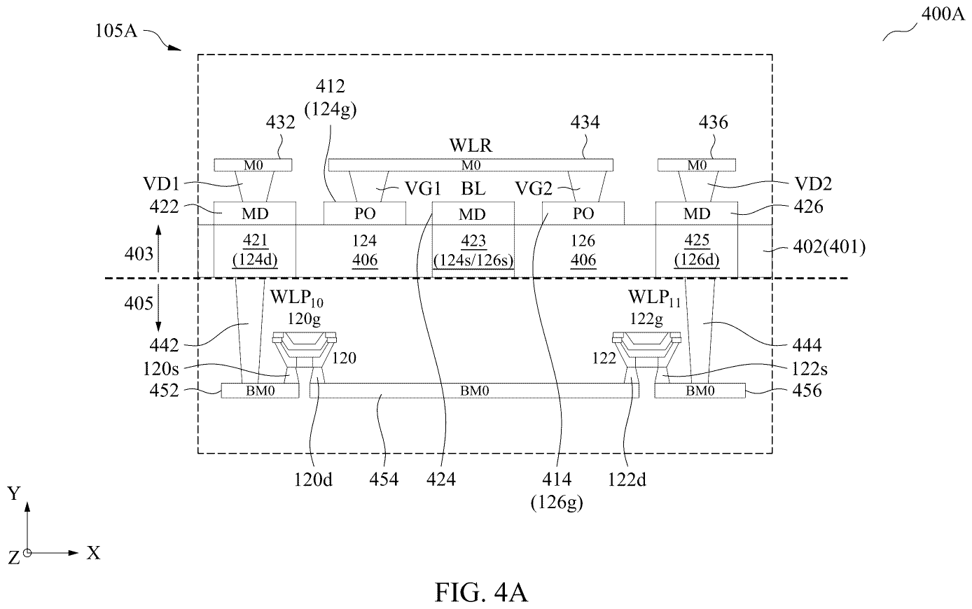

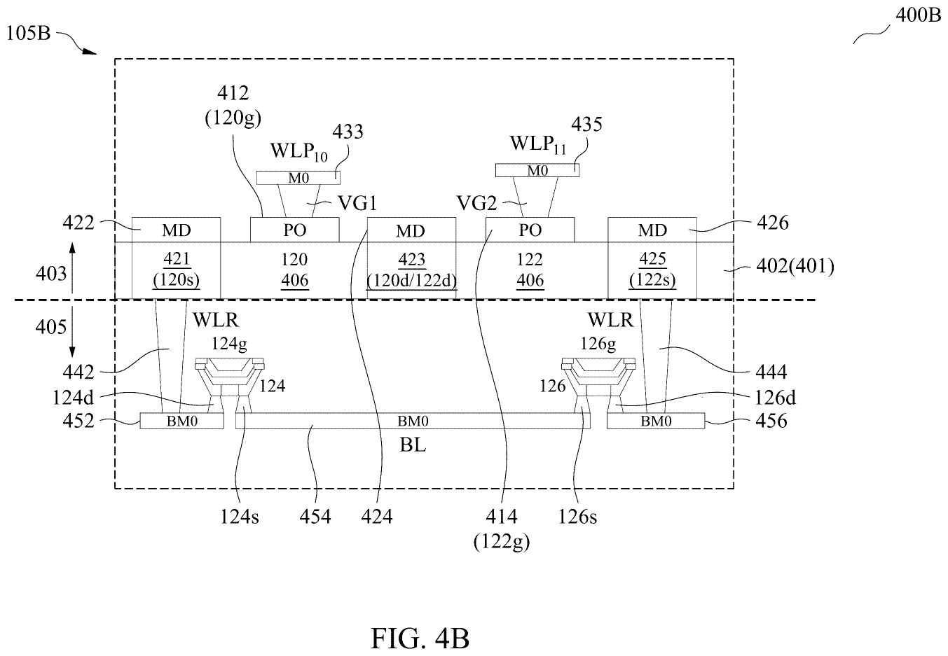

Various configurations of the memory cell 105 having at least one transistor, e.g., a 2D access transistor 10 (alternatively referred to as a thin film transistor 10) or a 3D access transistor 50, formed as a part of the backside network are described in detail in reference to memory devices 400A, 400B, 500, 700A, 700B, and 700C, as depicted in FIGS. 4A, 4B, 6, 8A, 8B, and 8C, respectively, below. Components common to these devices are described using the same reference numerals for purposes of simplicity.

FIG. 4A illustrates a cross-sectional view of the memory device 400A including at least a memory cell 105A (105) that corresponds to an embodiment of the memory cell 103A as shown in FIG. 2A in accordance with some embodiments. In some embodiments, the memory cell 105A is implemented in a four-transistor (4T) configuration according to the circuit diagram 200A of FIG. 2A, and thus some references of FIG. 2A will be reused. The memory cell 105A is used as a representative example, however, the structure and configuration of each of the memory cells 103 in FIG. 1A can be the same as or similar to the memory cell 105A.

In the present embodiments, the memory cell 105A is configured as an anti-fuse memory cell having at least one transistor formed (or provided) on a frontside 403 (alternatively referred to as a first side 403 or a first surface 403) or along a major surface on the frontside 403 of a substrate 401 and at least one transistor formed (or provided) on a backside 405 (alternatively referred to as a second side 405 or a second surface 405) or along a major surface on the backside 405 of the substrate 401 of the memory device 400A, where the backside 405 is opposite to the frontside 403. For example, referring to FIG. 4A, the memory cell 105A includes a first reading transistor 124 and a second reading transistor 126 formed on the frontside 403, and a first programming transistor 120 and a second programming transistor 122 formed on the backside 405. The memory cell 105A is configured as an anti-fuse cell to randomly present either a first logic state or a second logic state as described in detail above with respect to FIG. 2A. In some embodiments, either a gate dielectric layer of the first programming transistor 120 or a gate dielectric layer of the second programming transistor 122 is randomly broken down to present the first logic state or the second logic state.

In some embodiments, referring to FIG. 4A, the first programming transistor 120 (e.g., programming transistor 120A of FIG. 2A) and the second programming transistor 122 (e.g., programming transistor 122A of FIG. 2A) are formed on the backside 405 in a backside metallization layer BM0, where they are respectively gated by a first programming word line WLP₁₀ and a second programming word line WLP₁₁. In some embodiments, the first programming transistor 120 and the second programming transistor 122 are coupled in series through a BM0 metal track 454 on the backside 405, which is a part of the backside network.

The first reading transistor 124 (e.g., reading transistor 124A of FIG. 2A) and the second reading transistor 126 (e.g., reading transistor 126A of FIG. 2A), on the other hand, are formed over the frontside 403 as a part a part of the FEOL network, where they are commonly gated by a reading word line WLR. The first reading transistor 124 and the second reading transistor 126 are coupled in series through a common source/drain terminal (e.g., a source/drain structure 423), which is further coupled to a bit line BL on the frontside 403. In some embodiments, both the WLR and the BL are formed as parts of a back-end-of-line (BEOL) network over the FEOL network on the frontside 403.

Furthermore, in the present embodiments, the first reading transistor 124 is coupled to the first programming transistor 120 in series through a first backside via 442 (alternatively Att. referred to as a first via 442), and the second reading transistor 126 is coupled to the second programming transistor 122 in series through a second backside via 444 (alternatively referred to as a second via 444), where each of the first backside via 442 and the second backside via 444 extends from the backside 405 to the frontside 403.

Referring to FIG. 4A, the memory device 400A includes an active region 402 formed on the frontside 403 of the substrate 401 and extending in the first lateral direction, and a first gate structure 412 and a second gate structure 414 each extending along the second lateral direction perpendicular to the first lateral direction in a top view (not depicted herein) of the memory device 400A. As the first gate structure 412 and the second gate structure 414 are configured to form active devices, they are also referred to as the first active gate structure 412 and the second active gate structure 414, respectively. In the present embodiment, the first gate structure 412 and the second gate structure 414 respectively serve and are alternatively referred to as gate terminals of the first reading transistor 124 and the second reading transistor 126. In some embodiments, they are both coupled to (i.e., commonly gated by) the WLR as described above.

The active regions and gate structures are referred to as a part of the FEOL network on the frontside 403 of the substrate 401 of the device 400A. Over the FEOL network, multiple frontside metallization layers are formed as a part of the BEOL network of the device 400A. As shown in FIG. 4A, the WLR and the BL may be formed as metal tracks in one or more of the frontside metallization layers as described above. A plurality of frontside contact structures coupling the FEOL network to the BEOL network are referred to as a part of middle-end-of-line (MEOL) network. A plurality of backside metallization layers, e.g., the BM0, are also formed on the backside 405 of the device 400A as described above. Aspects of the FEOL, the MEOL, and the BEOL networks, as well as the backside network including the BM0, are described in detail below.

In some embodiments, the active region 402 is configured as a three-dimensional (3D) structure extending lengthwise along the first lateral direction and protruding from the substrate 401 along a vertical direction (e.g., Z-direction) in the FEOL network. In one example, the active region 402 may include stack of nanostructures (e.g., nanosheets, nanorods, etc.; not depicted herein) separated from one another along the vertical direction and may be configured to form a nanosheet FET, e.g., a gate-all-around (GAA) FET, a fork FET, a complementary FET (CFET), etc. In this regard, each of the first gate structure 412 and the second gate structure 414 wraps around each of the nanostructures. In another example, the active region 402 may include a fin structure and may be configured to form a fin-like field-effect transistor (FinFET). In some embodiments, the active region 402 is embedded in the substrate 401 and configured to form a planar FET.

Portions of the stack overlaid by each of the first gate structure 412 and the second gate structure 414 are configured as channel regions 406 of a respective transistor (e.g., a programming transistor or a reading transistor) formed on the frontside 403, where each channel region 406 is interposed between a pair of source/drain structures (e.g., source/drain structures 421, 423, and 425) along the first lateral direction. Each of the source/drain structures 421, 423, and 425 includes an epitaxial semiconductor material (e.g., silicon, silicon-carbon, silicon germanium, or other suitable semiconductor material), which may be doped with a suitable dopant, such as a n-type dopant or a p-type dopant. In the depicted embodiment, the source/drain structure 423 is shared by the two adjacent reading transistors along the first lateral direction and coupled to the BL of the memory cell 105A, which is a part of the BEOL network. In this regard, the source/drain structure 423 may alternatively be referred to as a common source/drain structure 423 or a shared source/drain structure 423, and the two adjacent reading transistors are coupled in series at the source/drain structure 423.

In the depicted embodiment, the source/drain structures 421 and 423 and a portion of the first gate structure 412 defining the channel region 406 are configured to form the first reading transistor 124, while the source/drain structures 423 and 425 and a portion of the second gate structure 414 defining the channel region 406 are configured to form the second reading transistor 126. In this regard, the source/drain structure 421 is referred to as (or considered a part of) a first source/drain terminal 124d of the first reading transistor 124, the source/drain structure 425 is referred to as (or considered a part of) a first source/drain terminal 126d of the second reading transistor 126, and the source/drain structure 423 is referred to as (or considered a part of) a second source/drain terminal 124s/126s of the first reading transistor 124 and the second reading transistor 126. In addition, the portion of the first gate structure 412 overlaying the channel region 406 is referred to as a gate terminal 124g of the first reading transistor 124, and the portion of the first gate structure 414 overlaying the channel region 406 is referred to as a gate terminal 126g of the first reading transistor 126. Further, the gate terminals 124g and 126g are both coupled to (i.e., are commonly gated by) the WLR in the BEOL network on the frontside 403 as described above. In the present disclosure, the “source/drain terminal” of a given transistor may be configured as a source terminal or a drain terminal.

As shown in FIG. 4A, the MEOL network of the device 400A includes a plurality of source/drain contact structures MDs (e.g., MDs 422, 424, and 426) formed over the FEOL network and electrically coupled to the corresponding source/drain structures (e.g., source/drain structures 421, 423, and 425) of the first reading transistor 124 and the second reading transistor 126. Each source/drain contact structure may be coupled to an upper interconnect structure (e.g., a frontside metallization layer M0) through a middle-end via structure VD (e.g., VD1 and VD2). Similarly, each of the first gate structure 412 and the second gate structure 414 (e.g., gate structures PO) may be coupled to an upper interconnect structure (e.g., the frontside metallization layer M0) through a gate contact structure VG (e.g., VG1 and VG2). The MDs, VDs, and VGs in the MEOL network may be formed in a corresponding dielectric layer (not depicted herein) that includes an inter-layer dielectric (ILD) layer, a contact-etch stop layer (CESL), or a combination thereof.

In various figures provided herein, the notation “MD” may be used to describe any suitable source/drain contact structure, the notation “VD” may be used to describe any suitable middle-end via structure, the notation “VG” may be used to describe any suitable gate contact structure, the notation “M0” may be used to describe any suitable metal track in the M0 metallization layer on the frontside 403, and the notation “BM0” may be used to describe any suitable metal track in the BM0 metallization layer on the backside 405.

The BEOL network may include a plurality of frontside metallization layers (e.g., M0) coupled by interconnect structures, such as via structures (not depicted herein). Each frontside metallization layer may include a plurality of metal tracks or metal lines embedded in a corresponding dielectric layer (e.g., a frontside inter-metal dielectric (IMD) layer similar to the ILD layer). For example, as shown in FIG. 4A, the memory device 400A includes metal tracks 432, 434, and 436 in the M0, which are also referred to as M0 metal tracks 432, 434, and 436, respectively. Additional frontside metallization layers (e.g., M1, M2, etc.) and their corresponding interconnect structures may be formed over the M0 on the frontside 403.

In the depicted embodiment, the metal track 432 is coupled to the MD 422 through the VD1; the metal track 434 is coupled to the first gate structure 412 and the second gate structure 414 through the VG1 and VG2, respectively; and the metal track 436 is coupled to the MD 426 through the VD2. The metal track 434 is further coupled to the WLR in a frontside metallization layer (e.g., M1) above the M0 through additional interconnect structures in the BEOL network (not depicted). Similarly, the MD 424, which is coupled to the common source/drain structure 423 of the first reading transistor 124 and the second reading transistor 126, is coupled to the BL in a frontside metallization layer (e.g., M1) above the M0 through additional interconnect structures in the BEOL network (not depicted). In some embodiments, the WLR and the BL are disposed in the same frontside metallization layer (not depicted) in the BEOL network. In some embodiments, the WLR and the BL are disposed in different frontside metallization layers (not depicted) in the BEOL network. The BL may be coupled to a supply voltage (VDD) in some embodiments, and to the ground (Vss) in other embodiments.

As shown in FIG. 4A, the memory device 400A further includes metal tracks 452, 454, and 456 in the BM0 on the backside 405 of the substrate 401. The metal tracks 452, 454, and 456 are thus alternatively referred to as BM0 metal tracks 452, 454, and 456, respectively. While additional backside metallization layers (e.g., BM1, BM2, etc.) may be disposed over the backside 405, each of which includes one or more metal tracks or metal lines embedded in a corresponding dielectric material (e.g., a backside IMD similar to the frontside IMD in composition), only the BM0 is shown herein for the sake of simplicity. Each of the backside metallization layers may be configured as a portion of the backside network described herein.

Still referring to FIG. 4A, the first programming transistor 120 and the second programming transistor 122 are coupled to the BM0 metal tracks 452, 454, and 456. In some embodiments, as described in reference to FIG. 2A, a first source/drain terminal 120d of the first programming transistor 120 and a first source/drain terminal 122d of the second programming transistor 122 are coupled to each other by the BM0 metal track 454, which is floating. In this regard, the BM0 metal track 454 may also be referred to as a common BM0 metal track 454.

The first programming transistor 120 and the second programming transistor 122 are also respectively coupled to the first reading transistor 124 and the second reading transistor 126 in series through the first backside via 442 and the second backside via 444. For example, the first backside via 442 couples a second source/drain terminal 120s of the first programming transistor 120 to the source/drain structure 421 (i.e., the first source/drain terminal 124d) of the first reading transistor 124, and the second backside via 444 couples a second source/drain terminal 122s of the second programming transistor 122 to the source/drain structure 425 (i.e., the first source/drain terminal 126d) of the second reading transistor 126. The source/drain structure 423 (i.e., the second source/drain terminal 124s/126s) of each of the first reading transistor 124 and the second reading transistor 126 commonly shared between the two reading transistors 124 and 126 is coupled to the BL as described above. In some embodiments, the second source/drain terminal 120s is coupled to the first backside via 442 through the BM0 metal track 452, and the second source/drain terminal 122s is coupled to the second backside via 444 through the BM0 metal track 456.

In some embodiments, the first programming transistor 120 and the second programming transistor 122 are each configured as an access transistor having its source/drain terminals coupled to two different BM0 metal tracks as described above. In addition, a gate terminal 120g (i.e., a gate structure 120g) of the first programming transistor 120 is coupled to a first programming word line WLP₁₀ and the gate terminal 122g (i.e., a gate structure 122g) of the second programming transistor 122 is coupled to a second programming word line WLP₁₁. In some embodiments, the WLP₁₀ and the WLP₁₁ are formed as metal tracks in an additional backside metallization layer below the BM0 (not depicted) that is further away from the frontside 403.

When the memory cell 105A is programmed, a gate dielectric layer of one of the two programming transistors 120 or 122 is configured to be broken down faster than the other one of the programming transistors. Specifically, either a portion of a gate dielectric layer (e.g., a portion between the source/drain terminal 120s and the gate terminal 120g) of the programming transistor 120 or a portion of a gate dielectric layer (e.g., a portion between the source/drain terminal 122s and the gate terminal 122g) of the programming transistor 122 is precedingly broken down. As the gate terminal 120g of the programming transistor 120 and the gate terminal 122g of the programming transistor 122 are isolated from each other (as they are respectively gated by the WLP₁₀ and the WLP₁₁), such a preceding breakdown can randomly and individually occur. Consequently, the memory cell 105A can be “randomly” programmed to a first logic state or a second logic state, as described in detail above with respect to FIG. 2A. Whether the first or second logic state is programmed into the memory cell can correspond to which of the programming transistors is broken down (first), which may be determined based on a further reading process.

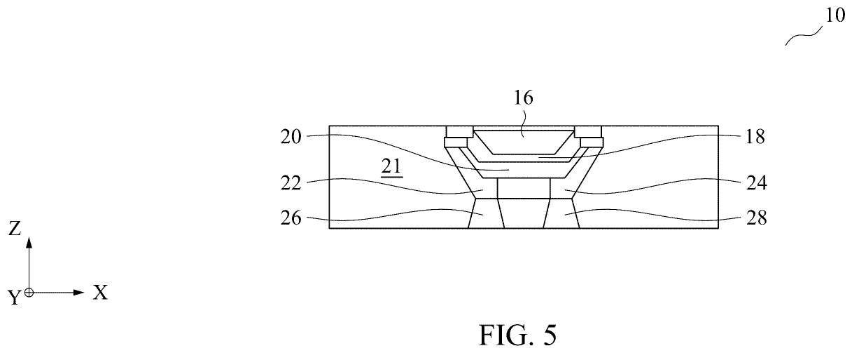

FIG. 5 illustrates an embodiment of a 2D access transistor 10 in accordance with some embodiments. As shown, the 2D access transistor 10 includes a plurality of thin films configured as various components of the transistor and is therefore also referred to as a thin film transistor 10. In some embodiments, the 2D access transistor 10 includes a gate electrode 16, a gate dielectric layer 18 disposed over the gate electrode 16, a channel layer 20 disposed over the gate dielectric layer 18, and a pair of source/drain structures 22 and 24 disposed over the channel layer 20. The 2D access transistor 10 may further include a pair of source/drain contacts 26 and 28 respectively coupled to the source/drain structures 22 and 24, where the source/drain contacts 26 and 28 are configured to interconnect the corresponding source/drain structures 22 and 24 to other transistor(s) through a metal track in a backside metallization layer (e.g., one of the metal Att. tracks 452-456 in the BM0). In some embodiments, at least a portion of the 2D access transistor 10 is formed in an IMD layer 21 on a backside of a substrate 401.

The 2D access transistor 10 may also be referred to as a “thin film transistor,” a “2D back-gate transistor,” or simply a “2D transistor,” because the gate electrode 16 is formed as a relatively planar or thinner structure such that the channel layer 20 extends over a 2D planar top surface of the gate electrode 16. In some embodiments, implementing the gate dielectric layer 18 as a relatively thinner film allows the gate dielectric layer 18 (or a portion thereof) to break down relatively easier (e.g., requiring a lower programming voltage), rendering an improved performance in the programming transistor (e.g., the first programming transistor 120 and the second programming transistor 122) of the programmed memory cell.

In some embodiments, the gate electrode 16 includes a conductive material, such as titanium (Ti), titanium nitride (TiN), tantalum (Ta), tantalum nitride (TaN), tungsten (W), copper (Cu), cobalt (Co), ruthenium (Ru), aluminum (Al), silver (Ag), gold (Au), platinum (Pt), polycrystalline silicon (polysilicon), the like, or combinations thereof. The gate dielectric layer 18 may be any suitable dielectric material, such as silicon oxide, silicon nitride, a high-k dielectric material (e.g., a dielectric material having a dielectric constant greater than that of silicon oxide, which is about 3.9). Example high-k dielectric materials include a metal oxide and/or a metal silicate of Hf, Al, Zr, La, Mg, Ba, Ti, Pb, the like, or combinations thereof.

In some embodiments, the channel layer 20 includes a doped or undoped semiconductor material. In some embodiments, the channel layer 20 includes a metal-containing semiconductor material. Example semiconductor materials include indium gallium zinc oxide (IGZO), indium tin oxide (ITO), indium zinc oxide (IZO), indium tungsten oxide (IWO), Si (e.g., polysilicon or amorphous silicon), Ge, SiGe, silicon carbide (SiC), the like, or combinations thereof. The source/drain structures 22 and 24 each include a conductive material similar to that of the gate electrode 16. In an example embodiment, the gate electrode 16 include TiN, the gate dielectric layer 18 includes hafnium oxide (HfO₂), the channel layer 20 includes IGZO, and the source/drain structures 22 and 24 each include TiN.

The 2D access transistor 10 as shown in FIG. 5 can be implemented as any one of the first programming transistor 120 or the second programming transistor 122 on the backside 405 of the memory device 400A. In this regard, the gate electrode 16 may correspond to the gate terminal 120g of the first programing transistor 120 and the second programming transistor 122, respectively. Similarly, the source/drain structures 22 and 24 may correspond to the first source/drain terminal 120d and the second source/drain terminal 120s of the first programming transistor 120, respectively. Due to its structure (such as thinner gate oxide), the thin film nature of the gate dielectric layer 18 causes it to be relatively easier to break down (or programmed), thereby obtaining relatively faster programming speed and relatively lower programming voltage. The access transistor 10 may also be implemented as a reading transistor (see FIG. 4B) disposed on the backside of a memory device.

FIG. 4B illustrates a cross-sectional view of the memory device 400B including at least a memory cell 105B (105) that corresponds to another embodiment of the memory cell 103A as shown in FIG. 2A. The memory cell 105B in FIG. 4B is used as a representative example, however, the structure and configuration of each of the memory cells 103 in FIG. 1A can be the same as or similar to the memory cell 105B as shown in FIG. 4B.

The memory cell 105B, configured as an anti-fuse memory cell, is similar to the memory cell 105A of FIG. 4A in some respects. For example, the memory cell 105B includes the first reading transistor 124 and the second reading transistor 126 coupled to one another in series at a common source/drain terminal and commonly gated by the WLR. Specifically, the source/drain terminals 124s and 126s are shared and commonly coupled to the BL, and the gate terminals 124g and 126g are commonly gated by the WLR. Furthermore, the memory cell 105B includes the first programming transistor 120 and the second programming transistor 122 coupled to one another in series at a common source/drain terminal and gated by WLP₁₀ and WLP₁₁, respectively. Specifically, the source/drain terminals 120d and 122d are commonly shared (e.g., as the source/drain structure 423) and are floating. Still further, similar to FIG. 4A, FIG. 4B illustrates that the first reading transistor 124 in the memory cell 105B is coupled to the first programming transistor 120 in series through the backside via 442 and the second reading transistor 126 is coupled to the second programming transistor 122 in series through the backside via 444. Accordingly, the memory cell 105B is also representative of the circuit diagram depicted n FIG. 2A, as in the memory cell 105A.

However, different from the memory cell 105A of FIG. 4A, the reading transistors 124 and 126 in the memory cell 105B are disposed (or formed) on the backside 405 of the substrate 401, while the programming transistors 120 and 122 are disposed (or formed) on the frontside 403 of the substrate 401. As such, the source/drain terminals 124s and 126s are commonly coupled to the BM0 metal track 454, the source/drain terminal 124d is coupled to the BM0 metal track 452, and the source/drain terminal 126d is coupled to the BM0 metal track 456 in the memory cell 105B, which are each a different configuration from that of the memory cell 105A. Similarly, the source/drain terminals 120d and 122d are commonly coupled to the MD 424, the source/drain terminal 120s is coupled to the MD 422, and the source/drain terminal 122s is coupled to the MD 426, which are each a different configuration from that of the memory cell 105A. Furthermore, the WLR is implemented as a metal track in a backside metallization layer (not depicted), while the WLP₁₀ and the WLP₁₁ are respectively implemented as metal tracks 433 and 435 in one or more frontside metallization layers (not depicted).

Accordingly, referring to FIGS. 4A and 4B collectively, the present disclosure provides embodiments of anti-fuse memory cells in which transistors of a first type (e.g., reading) and transistors of a second type (e.g., programming) different from the first type are disposed on opposite sides of a substrate such that they respectively belong to the FEOL network and the backside network of a memory device. In this regard, the programming transistors are physically separated from the reading transistors across portions of the FEOL network and the backside network. In some examples, by forming a portion of the memory cell 105 (e.g., the programming transistors in FIG. 4A or the reading transistors in FIG. 4B) on the backside 405, cell area on the frontside 403 may be reduced, thereby improving cell density as well as allowing additional routing options to be achieved on one or both of the frontside 403 and the backside 405. In some examples, the programming voltage of each memory cell 105A may also be reduced, thereby leading to improved performance of the memory device.

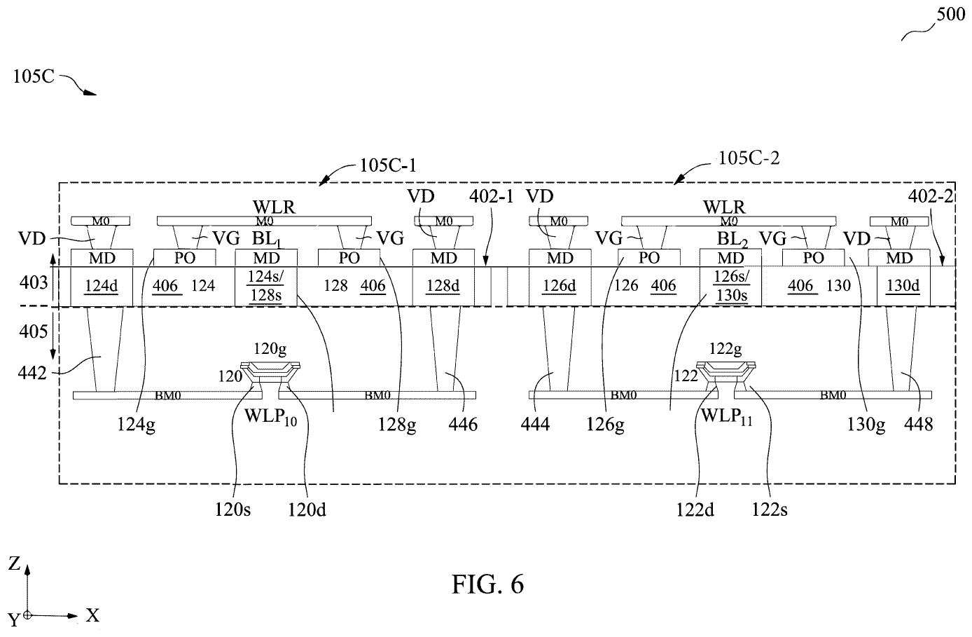

FIG. 6 illustrates a cross-sectional view of a memory device 500 including at least a memory cell 105C (105) that corresponds to another embodiment of the memory cell 103A as shown in FIG. 2C. In some embodiments, the memory cell 105C of the memory device 500 is implemented in a six-transistor (6T) configuration according to the circuit diagram 200C in FIG. 2C, and thus some references of FIG. 2C will be reused. The memory cell 105C in FIG. 6 is used as a representative example, however, the structure and configuration of each of the memory cells 103 in FIG. 1A can be the same as or similar to the memory cell 105C as shown in FIG. 6.

Referring to FIGS. 2C and 6, the memory cell 103A includes a first portion 105C-1 coupled to a second portion 105C-2 in an example configuration described below. In some embodiments, the first portion 105C-1 includes the first programming transistor 120 coupled in series between the first reading transistor 124 and a third reading transistor 128, and the second portion 105C-2 includes the second programming transistor 122 coupled in series between the second reading transistor 126 and a fourth reading transistor 130. In some embodiments, the reading transistors 128 and 130 are each substantially the same as the first reading transistor 124 or the second reading transistor 126 in structure and function as described above.

In some embodiments, the first portion 105C-1 is disposed (or formed) over a first active region 402-1 of the substrate 401 of the memory device 500 and the second portion 105C-2 is disposed (or formed) over a second active region 402-2 of the substrate 401 of the memory device 500, where the substrate 401 includes the frontside 403 and the backside 405 as described above. In this regard, the reading transistors 124, 126, 128, and 130 are disposed on the frontside 403 of the substrate, while the programming transistors 120 and 122 are disposed on the backside 405 of the substrate 401. In this way, similar to the memory devices 400A and 400B, the area and the programming voltage for each memory cell 105C in the memory device 500 can be reduced, thereby leading to relatively high density of the memory cells 105C in the memory device 500 and improved performance of the memory device 500.

As shown in FIG. 6, the reading transistors 124 and 128 are coupled in series at commonly shared source/drain terminals 124s and 128s and are also commonly gated by the WLR through the gate terminals 124g and 128g, respectively, while the reading transistors 126 and 130 are coupled in series at commonly shared source/drain terminals 126s and 130s and commonly gated by the WLR through the gate terminals 126g and 130g, respectively. In some embodiments, the WLR is implemented as a metal track in one of the frontside metallization layers. In some embodiments, the source/drain terminals 124s and 128s are coupled to a first bit line BL₁ and the source/drain terminals 126s and 130s are coupled to a second bit line BL₂, where the BL₁ and the BL₂ are each substantially similar to the BL described above and may be implemented as metal tracks in one or more of the frontside metallization layers (not depicted).

Furthermore, the source/drain terminals 120s and 120d of the first programming transistor 120 are coupled to the reading transistors 124 (e.g., at source/drain terminal 124d) and 128 (e.g., at source/drain terminal 128d) through backside vias 442 and 446, respectively. Similarly, the source/drain terminals 122s and 122d of the second programming transistor 122 are coupled to the reading transistors 126 (e.g., at source/drain terminal 126d) and 130 (e.g., at source/drain terminal 130d) through backside vias 444 and 448, respectively. In some embodiments, the backside vias 446 and 448 are substantially the same as the backside vias 442 and 444 in structure and function as described above.

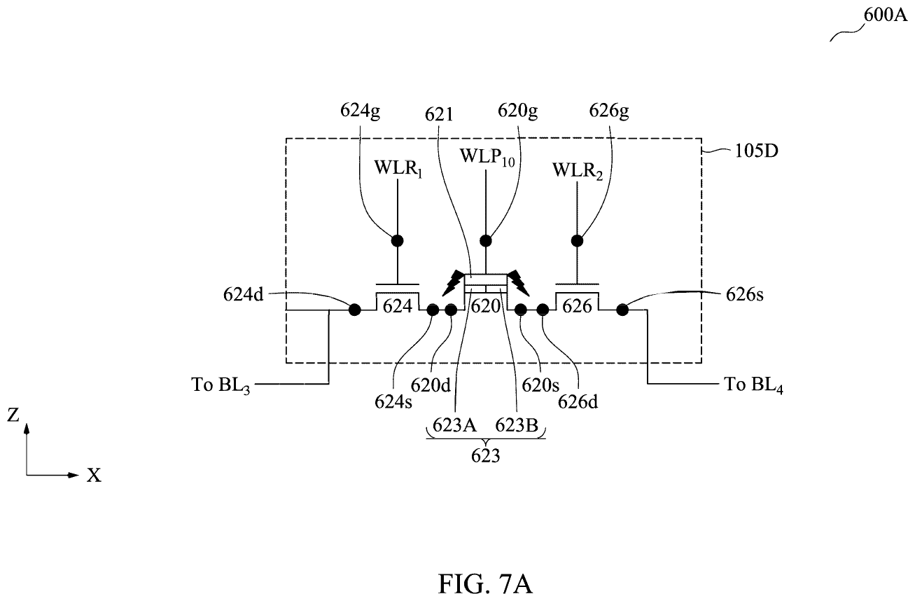

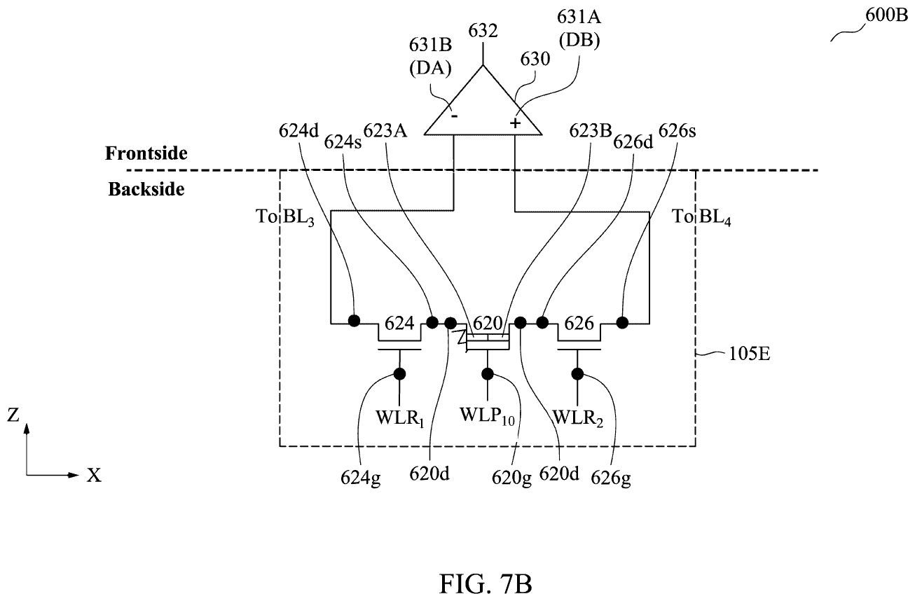

FIGS. 7A and 7B illustrate example circuit diagrams of memory cells 105D and 105E, respectively, collectively referred to as embodiments of the memory cells 105 in accordance with embodiments of the memory cell 103 of FIG. 1A. In some embodiments, memory cell 105D and 105E are embodied as memory cells in circuit diagrams 600A and 600B, respectively.

As shown in FIG. 7A, in some embodiments, the memory cell 105D includes a programming transistor 620 gated by a programming word line WLP₀, a first reading transistor 624 gated by a first reading word line WLR₁, and a second reading transistor 626 gated by a second reading word line WLR₂. In this regard, the memory cell 105D is implemented as a memory cell having a three-transistor reading-programming-reading, or “3T RPR,” configuration. Specifically, the programming transistor 620 is coupled between a source/drain terminal 624s of the first reading transistor 624 and a source/drain terminal 626d of the second reading transistor 626 in series. A source/drain terminal 624d of the first reading transistor 624 is coupled to the first bit line BL₁, and a source/drain terminal 626s of the second reading transistor 626 is coupled to the second bit line BL₂.

In some embodiments, the programming transistor 620 includes a gate terminal 620g (i.e., a gate structure 620g) having a gate metal 621 over a gate dielectric layer 623. In some embodiments, the gate dielectric layer 623 includes a dielectric material and is deposited on a surface of the gate metal 621. In some embodiments, the dielectric material of the gate dielectric layer 623 includes a high-k dielectric material described above with respect to the gate dielectric layer 18. In some embodiments, the gate dielectric layer 623 includes a first dielectric portion 623A and a second dielectric portion 623B that have the same dimension and can be concurrently or separately turned on/off to enable/disable an access for programing or reading to the programming transistor 620.

In a programming process, to enable programming of the programming transistor 620, a program-enabling voltage (e.g., 1.2V) can be concurrently or separately applied to gate terminals 624g and 626g of the first reading transistor 624 and the second reading transistor 626, respectively. Upon being enabled, the programming transistor 620 can be programmed by applying a programming voltage (e.g., 5V) to the gate terminal 620g and applying a low bit line voltage (e.g., 0V) to the bit lines BL₁ and BL₂.

In the programming process, randomly, one of the first dielectric portion 623 A and the second dielectric portion 623B in the gate dielectric layer 623 of the programming transistor 620 of a selected memory cell 105D can be broken down faster than the other one, even though the possibility for any one of them is 50%. After one (e.g., the first dielectric portion 623A) of the first dielectric portion 623A and the second dielectric portion 623B has been broken down first, the programming process stops, and thus the other one (e.g., the second dielectric portion 623B) remains intact. Consequently, a logic state or bit (e.g., 1) of logic states (1 or 0) of the memory cell 105D can be randomly generated based on whether the first dielectric portion 623A or the second dielectric portion 623B of its gate dielectric layer 623 has been broken down, and thus a bit of the PUF signature for the memory cell 105D is generated. Such a mechanism of randomly generating the bit of the PUF signature for the memory cell 105D in FIG. 7A may apply to each of the memory cells 103 in FIG. 1A. In this way, the PUF signature of the memory device (e.g., corresponding to the memory diagram device 600A) including the memory cells 105D can be generated.

In a reading process, the memory cell 105D is selected and thus read by applying a reading selection voltage (e.g., 1.5V) to the gate terminal 620g of its programming transistor 620, applying a reading selection voltage (e.g., 0.75V) to the gate terminals 624g and 626g of the first reading transistor 624 and the second reading transistor 626, respectively, and applying a low bit line (BL) voltage (e.g., 0V) to corresponding source/drain terminals of the first reading transistor 624 and the second reading transistor 626 through bit lines BL₁ and BL₂, respectively.

FIG. 7B illustrates the circuit diagram 600B including the memory cell 105E according to some embodiments. The memory cell 105E corresponds to an embodiment of the memory cell 105D, as shown in FIG. 7A, connected to a differential amplifier 630, according to some embodiments. The differential amplifier 630 has a first input terminal 631A and a second input terminal 631B, which are respectively coupled to the bit lines BL₁ and BL₂, and an output terminal 632 to output a state result (e.g., 1 or 0) of the memory cell 105E. The result represents whether the first dielectric portion 623A or the second dielectric portion 623B of the gate dielectric layer 623 has been broken down based on an appreciable current detected in the first input terminal 631A or the second input terminal 631B, thereby determining a logic state of the memory cell 105E.

In the reading process, upon detecting an appreciable current in the first input terminal 631A, the first dielectric portion 623A is determined to have been broken down, and thus the memory cell 105E is determined to be in a first logic state “1.” Otherwise, upon detecting an appreciable current in the second input terminal 631B, the second dielectric portion 623B is determined to have been broken down, and thus the memory cell 105E is determined to be in second logic state “0.” Such a mechanism of reading a logic state of the memory cell 105E in FIG. 7B may apply to each of the memory cells 103 in FIG. 1A. In this way, a PUF signature of the memory device is read and thus authenticated.

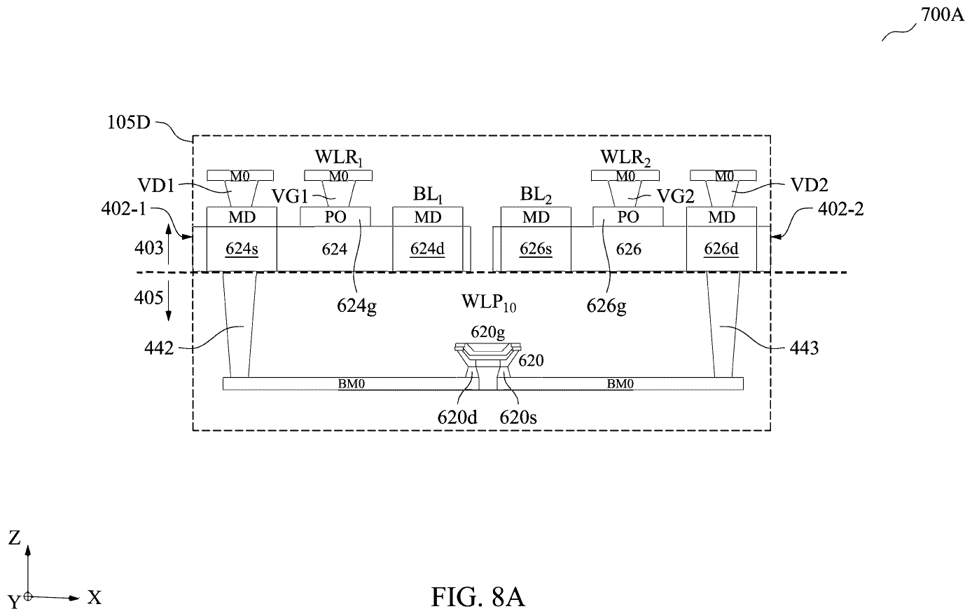

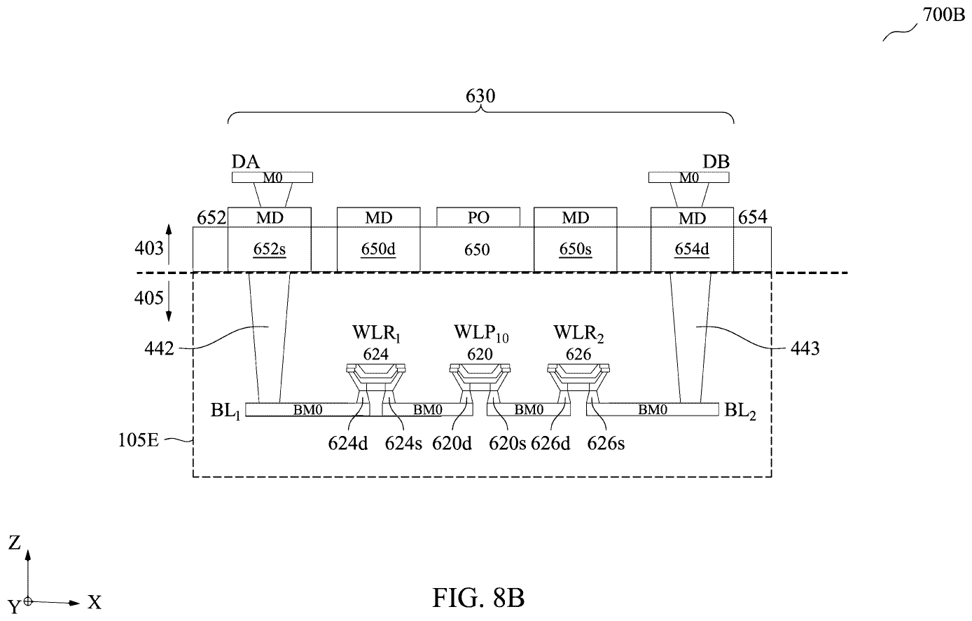

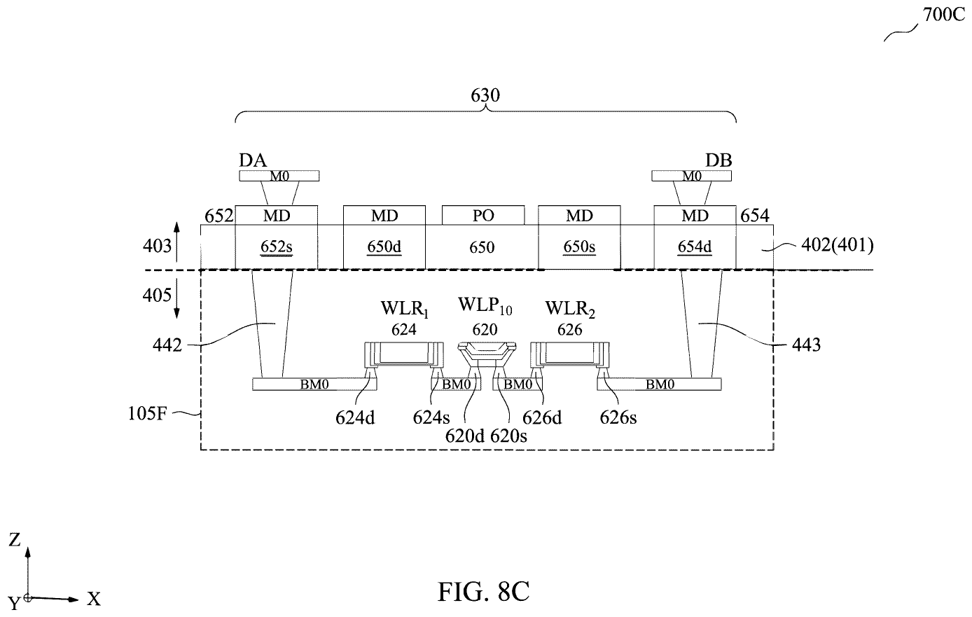

In the present embodiments, one or more of the transistors in the memory cells 105D and 105E is disposed (or formed) on a backside of a substrate. Using the memory cell 105D as an example, the programming transistor 620 may be disposed on a frontside of the substrate 401, while the first reading transistor 624 and the second reading transistor 626 may be disposed on a backside of the substrate. Alternatively, the programming transistor 620 may be disposed on the backside of the substrate, while the first reading transistor 624 and the second reading transistor 626 may be disposed on the frontside of the substrate. Using the memory cell 105E as another example, all of the transistors in the memory cell 105E, including the programing transistor 620, the first reading transistor 624, and the second reading transistor 626, are disposed on a backside of the substrate, while the differential amplifier 630 is disposed on a frontside of the substrate. In each of the above examples, the frontside transistor(s) and the backside transistor(s) are coupled through backside vias, such as the backside vias 442-448 described above with respect to the memory cells 105A-105C. Example implementations of the circuit diagrams 600A and 600B are described below in reference to FIGS. 8A, 8B, and 8C.

FIG. 8A illustrates a cross-sectional view of a memory device 700A configured based on the circuit diagram 600A including the memory cell 105D, as depicted in FIG. 7A. As described above, the memory cell 105D is implemented as a memory cell having a 3T RPR configuration as shown in FIG. 7A. As such, reference numerals depicted in FIG. 7A are repeated in FIG. 8A for purposes of consistency.

As described above, the memory cell 105D is programmed to randomly present a first logic state or a second logic state, thereby achieving a PUF signature as a means of authentication. The memory cell 105D includes the programming transistor 620, the first reading transistor 624, and the second reading transistor 626, where the programming transistor 620 is disposed on the backside 405 as a part of the backside network, and the first reading transistor 624 and the second reading transistor 626 are disposed on the frontside 403 as a part of the FEOL network. As shown, the programming transistor 620 formed in the backside network is vertically farther separated from each of the first reading transistor 624 and the second reading transistor 626, which are formed in the FEOL network. In this way, the area and the programming voltage for the memory cell 105D can be reduced, thereby leading to higher density of the memory cells 105D in the memory device 700A and improved performance of the memory device 700A.

In some embodiments, the first reading transistor 624 is disposed in the first active region 402-1 of the substrate 401 of the memory device 700A and the second reading transistor 626 is disposed in the second active region 402-2 of the substrate 401. In some embodiments, the first active region 402-1 and the second active region 402-2 are separated from one another by a dielectric structure (not depicted). In some embodiments, the programming transistor 620 is implemented as the 2D access transistor 10 described above in reference to FIG. 5, which can be programmed by a relatively low programming voltage.

In some embodiments, the programming transistor 620 is coupled between the first reading transistor 624 and the second reading transistor 626 in series through backside vias 442 and 443, respectively, where the backside via 443 is substantially similar to the backside via 442 as described above. The memory device 700A also includes the bit lines BL₁ and BL₂ respectively coupled to the source/drain terminal 624d of the first reading transistor 624 and the source/drain terminal 626s of the second reading transistor 626. The programming transistor 620 is gated by the WLP₁₀ through the gate terminal 620g, while the first reading transistor 624 and the second reading transistor 626 are gated by the WLR₁ and the WLR₂ through the gate terminals 624g and 626g, respectively. As depicted herein, the WLP₁₀ is implemented as a metal track in one of the backside metallization layers, while the WLR₁, the WLR₂, the BL₁, and the BL₂ are each implemented as a metal track in one of the frontside metallization layers.

FIG. 8B illustrates a cross-sectional view of a memory device 700B configured based on the circuit diagram 600B including the memory cell 105E, as depicted in FIG. 7B. As described above, the memory cell 105E is implemented as a memory cell having a 3T RPR configuration and the memory device 700B includes a differential amplifier 630 as shown in FIG. 7B. In some embodiments, the memory cell 105E is similar, though not identical, to the memory cell 105D but have some differences. As such, some reference numerals depicted in FIG. 7B are repeated in FIG. 8B for purposes of consistency.

As described above and similar to the memory cell 105D, the memory cell 105E is programmed to randomly present a first logic state or a second logic state, thereby achieving a PUF signature as a means of authentication. In this regard, the memory cell 105E includes the programming transistor 620, the first reading transistor 624, and the second reading transistor 626, where the programming transistor 620 is coupled in series between the first reading transistor 624 and the second reading transistor 626. In some embodiments, all the programming transistor 620, the first reading transistor 624, and the second reading transistor 626 are implemented as 2D access transistors 10 as shown in FIG. 5, which can be programmed by a relatively low programming voltage. In some embodiments, the source/drain terminals 620s, 620d, 624s, 624d, 626s and 626d of the transistors 620-626 are each coupled to a metal track in the BM0. Furthermore, the source/drain terminal 624d of the first reading transistor 624 is coupled to the BL₁, while the source/drain terminal 626s of the second reading transistor 626 is coupled to the BL₂.

However, in some embodiments, different from the memory cell 105D, the programming transistor 620, the first reading transistor 624, and the second reading transistor 626 are all disposed on the backside 405 as a part of the backside network, while the differential amplifier 630 is disposed on the frontside 403. As shown, the programming transistor 620 formed in the backside network is vertically farther separated from each of the first reading transistor 624 and the second reading transistor 626, which are formed in the FEOL network. In this way, the area and the programming voltage for the memory cell 105E can be reduced, thereby leading to higher density of the memory cells 105E in the memory device 700B and improved performance of the memory device 700B.

In some embodiments, still referring to FIG. 8B, the memory device 700B further includes a plurality of peripheral components, such as transistors 650, 652 and 654, disposed on the frontside 403 of the substrate 401 as a part of the FEOL network. In some embodiments, the transistors 652 and 654 are respectively coupled to the first input terminal 631A (DB) and the second input terminal 641B (DA) of the differential amplifier 630, which is also disposed on the frontside 403 but above the FEOL network, such as a part of the BEOL network (not depicted). In some embodiments, a source/drain terminal 652s of the transistor 652 is coupled to the first input terminal 631A and a source/drain terminal 654d of the transistor 654 is coupled to the second input terminal 631B.

Furthermore, the source/drain terminal 652s and the source/drain terminal 654d are coupled to the source/drain terminal 624d of the first reading transistor 624 and the source/drain terminal 626s of the second reading transistor 626 through the backside vias 442 and 443, respectively. In this regard, referring to FIGS. 7B and 8B collectively, the output from the differential amplifier 630 represents whether the first dielectric portion 623A or the second dielectric portion 623B of the gate dielectric layer 623 in the programming transistor 620 has been broken down based on an appreciable current detected in the first input terminal 631A or the second input terminal 631B, thereby determining a logic state of the memory cell 105E.

FIG. 8C illustrates a cross-sectional view of a memory device 700C configured based on the circuit diagram 600B including a memory cell 105F that is substantially similar to the memory cell 105E in some embodiments. As such, some reference numerals depicted in FIG. 7B are repeated in FIG. 8B for purposes of consistency.

For example, similar to the memory cell 105E, the memory cell 105F is implemented as a memory cell having a 3T RPR configuration and the memory device 700C includes a differential amplifier 630 coupled to the memory cell 105F as depicted in FIG. 8C. Specifically, the memory cell 105F includes the programming transistor 620, the first reading transistor 624, and the second reading transistor 626 all disposed on the backside 405 of the substrate 401, where the programming transistor 620 is coupled in series between the first reading transistor 624 and the second reading transistor 626. In some embodiments, the source/drain terminals of the transistors 620-626 are each coupled to a metal track in the BM0. Furthermore, the source/drain terminal 624d of the first reading transistor 624 is coupled to the BL₁, while the source/drain terminal 626s of the second reading transistor 626 is coupled to the BL₂.

However, in some embodiments, the memory cell 105F differs from the memory cell 105E in that, instead of implementing each of the transistors configured as the 2D access transistor 10, one or more of the first reading transistor 624 and the second reading transistor 626 are implemented as a 3D access transistor, while the programming transistor 620 remains as a 2D access transistor. In the depicted embodiment, for example, both the first reading transistor 624 and the second reading transistor 626 are implemented as 3D access transistors.

As described above in reference to FIG. 5, the 2D access transistor 10 includes the gate dielectric layer 18 implemented as a thin film, which the programming transistor 620 to be programmed at a lower voltage, leading to improved programming performance. In contrast, a 3D access transistor provides a larger contact area between a channel structure and a gate electrode of the transistor, thereby achieving a higher reading current and higher reading speed during operation. Accordingly, in some embodiments, configuring the programming transistor (e.g., the programming transistor 620) as a 2D access transistor and one or both of the reading transistors (e.g., the first reading transistor 624 and/or the second reading transistor 626) as 3D access transistor allows various aspects of the device performance to be tuned independently, thereby improving the overall driving capability of the memory device in various applications. In some embodiments, only one of the first reading transistor 624 and the second reading transistor 626 is implemented as a 3D access transistor. In some embodiments, both of the first reading transistor 624 and the second reading transistor 626 are implemented as 3D access transistors, as depicted in FIG. 8C.

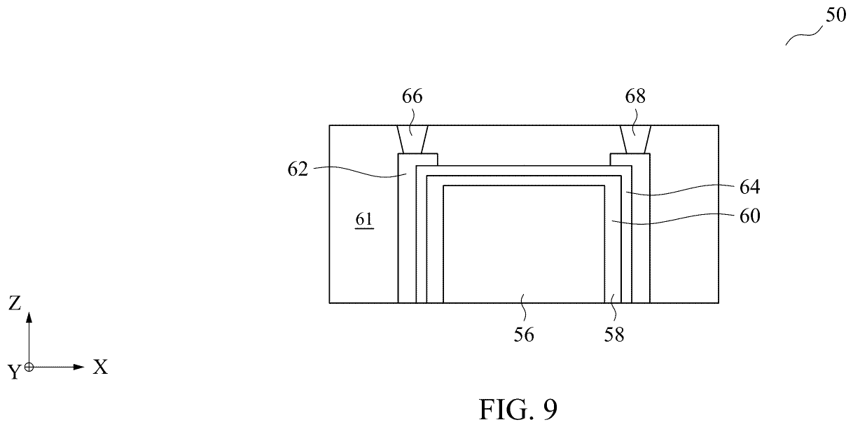

FIG. 9 illustrates an embodiment of a 3D access transistor 50 in accordance with other embodiments. As shown, the 3D access transistor 50 includes a gate electrode 56, a gate dielectric layer 58 disposed over the gate electrode 56, a channel layer 60 disposed over the gate dielectric layer 58, and a pair of source/drain structures 62 and 64 disposed over the channel layer 60. The 3D access transistor 50 may also be referred to as a “3D back-gate transistor” or simply a “3D transistor.” The 3D access transistor 50 may further include a pair of source/drain contacts 66 and 68 respectively coupled to the source/drain structures 62 and 64, where the source/drain contacts 66 and 68 are configured to interconnect the corresponding source/drain structures 62 and 64 to other transistor(s) through a metal track in a backside metallization layer (e.g., one of the metal tracks in the BM 0). In some embodiments, at least a portion of the 3D access transistor 50 is formed in an IMD layer 61 on a backside of a substrate.

The term “3D” may refer to the transistor having its gate electrode (e.g., the gate electrode 56) formed as a relatively protruding structure such that the channel structure (e.g., the channel layer 60) contacts or traverses multiple surfaces of the gate electrode to increase a contact area therebetween. As described above, this increased contact area affords higher reading current and results in improved reading speed in a reading transistor, for example.

In some embodiments, the gate electrode 56, the gate dielectric layer 58, the channel layer 60, and the source/drain structures 62 and 64 have structures and composition that are similar to those of the gate electrode 16, the gate dielectric layer 18, the channel layer 20, and the source/drain structures 22 and 24 of the 2D access transistor 10, respectively. Accordingly, descriptions of these components of the 3D access transistor 50 are omitted herein for purposes of brevity. As described above, the 3D access transistor 50 may be implemented as one or both of the first reading transistor 624 and the second reading transistor 626 as shown in FIG. 8C.

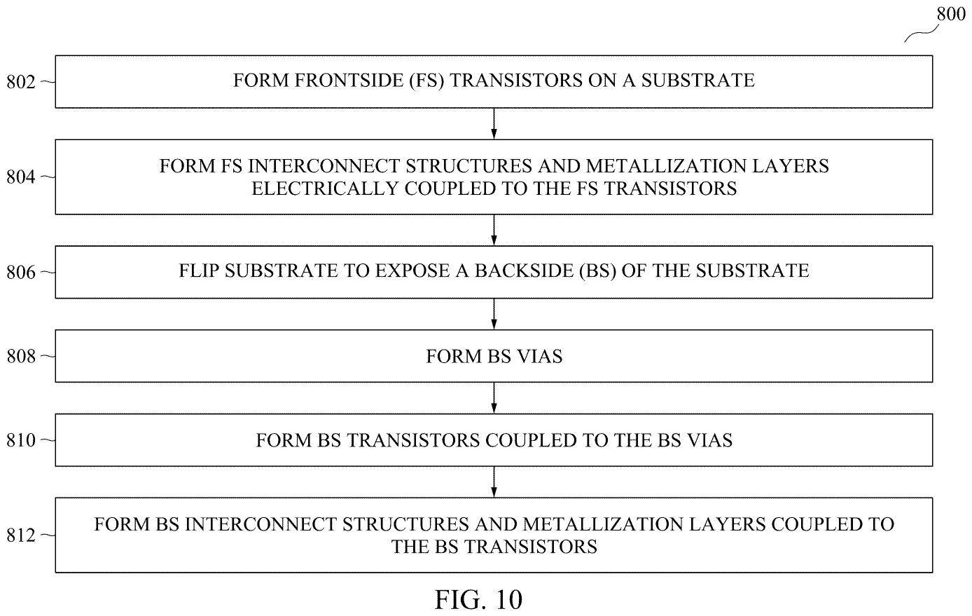

FIG. 10 illustrates a flow chart of an example method 800 for fabricating any of the memory devices 400A, 400B, 500, 700A, 700B, and 700C, in portion or in entirety, having the memory cell 105 (e.g., 105A-105F), according to some embodiments. It is noted that the method 800 is merely an example and is not intended to limit the present disclosure. Accordingly, it is understood that additional operations may be provided before, during, and after the method 800, and that some other operations may only be briefly described herein. The order of the operations may be interchangeable.

In some embodiments, the method 800 is implemented to fabricate a memory device having a memory cell in which at least one of the transistors (programming or reading) in the memory cell is formed on a backside of a substrate of the memory device. In one such example, at least one of the transistors is formed on the backside of the substrate and at least one of the transistors is formed on a frontside of the substrate, such as in the memory devices 400A, 400B, 500, and 700A. In another such example, all of the transistors of the memory cell are formed on the backside of the substrate, such as in the memory devices 700B and 700C. In some embodiments, peripheral transistors (not a part of the memory cell) coupled to the backside transistors are formed on the frontside of the substrate, such as in the memory devices 700B and 700C. For purposes of illustration, the method 800 is described below in reference to the embodiment of the memory device 400A as depicted in FIG. 4A.

The method 800 starts with operation 802 during which one or more frontside transistors (alternatively referred to as first transistors), such as the first reading transistor 124 and the second reading transistor 126 as depicted in FIG. 4A, are formed on a frontside of a substrate, such as the frontside 403 of the substrate 401. The substrate includes multiple active regions, such as the active region 402, as described above. The frontside transistors may include at least one reading transistor (e.g., the reading transistor 124 and/or the reading transistor 126) or at least one programming transistor (e.g., the programming transistor 120 and/or the programming transistor 122) of any of the memory cells 105 as described above.

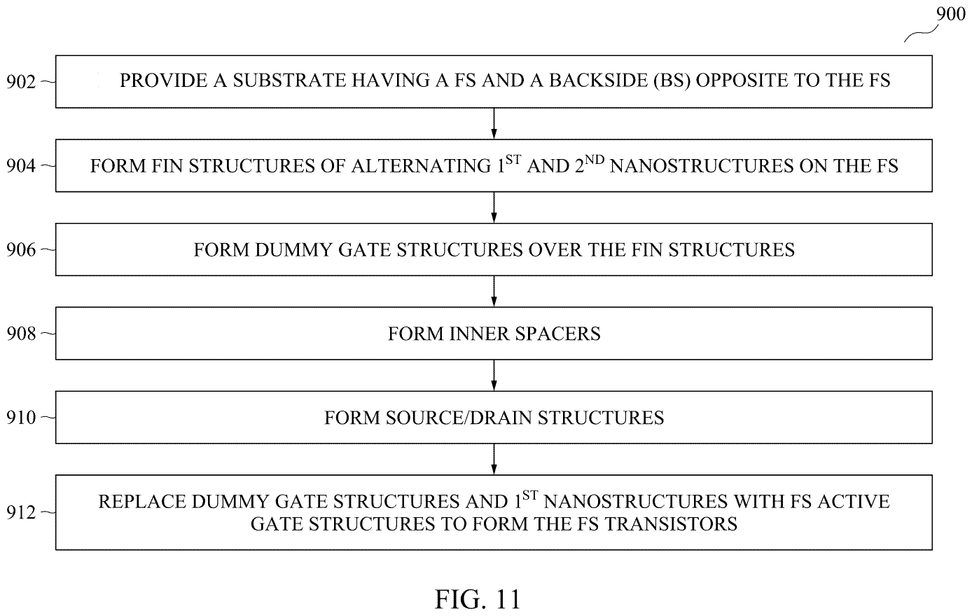

Referring to FIG. 11, the frontside transistors may be formed by a method 900, details of which are described below in reference to operations 902-912. It is noted that the method 900 is merely an example and is not intended to limit the present disclosure. Accordingly, it is understood that additional operations may be provided before, during, and after the method 900, and that some other operations may only be briefly described herein. The order of the operations may be interchangeable.

The method 900 starts with operation 902 during which the substrate, such as the substrate 401, is provided in accordance with various embodiments. The substrate includes the frontside, such as the frontside 403, opposite to a backside, such as the backside 405. The substrate may include a semiconductor material such as, for example, silicon (Si). Alternatively, the substrate may include other elementary semiconductor material such as, for example, germanium (Ge). The substrate may also include a compound semiconductor such as silicon carbide, gallium arsenic, indium arsenide, and indium phosphide. The substrate may include an alloy semiconductor such as silicon germanium, silicon germanium carbide, gallium arsenic phosphide, and gallium indium phosphide. In one embodiment, the substrate includes an epitaxial layer. For example, the substrate may have an epitaxial layer overlying a bulk semiconductor. Furthermore, the substrate may include a semiconductor-on-insulator (SOI) structure. For example, the substrate may include a buried oxide (BOX) layer formed by a process such as separation by implanted oxygen (SIMOX) or other suitable technique, such as wafer bonding and grinding.

The method 900 continues to operation 904 during which a stack (not depicted), including an alternating series of first nanostructures (e.g., nanosheets, nanorods, etc.) and second nanostructures, is formed on the frontside of the substrate (i.e., the active region 402) in accordance with various embodiments. Such a stack can be formed based on one of the (active region) patterns discussed above. The stack can be formed in a frontside of the substrate 401. In some embodiments, the first nanostructures may include SiGe sacrificial nanostructures, and the second nanostructures may include Si channel nanostructures. Such a stack may be referred to as a superlattice. In a non-limiting example, the SiGe sacrificial nanostructures may include any suitable amount of Ge, such as 15%, 25%, 30%, etc. It is understood the percentage of Ge in each of the SiGe sacrificial nanostructures can be any value between 0 and 100 (excluding 0 and 100), while remaining within the scope of present disclosure. In some other embodiments, the second nanostructures may include a first semiconductor material other than Si and the first nanostructures may include a second semiconductor material other than SiGe, as long as the first and second semiconductor materials are respectively characterized with different etching properties (e.g., etching rates).

The alternating series of nanostructures can be formed by epitaxially growing one layer and then the next until the desired number and desired thicknesses of the nanostructures are achieved. Epitaxial materials can be grown from gaseous or liquid precursors. Epitaxial materials can be grown using vapor-phase epitaxy (VPE), molecular-beam epitaxy (MBE), liquid-phase epitaxy (LPE), or other suitable process. Epitaxial silicon, silicon germanium, and/or carbon doped silicon (Si: C) silicon can be doped during deposition (in-situ doped) by adding dopants, n-type dopants (e.g., phosphorus or arsenic) or p-type dopants (e.g., boron or gallium), depending on the type of transistor.

Subsequently, a plurality of fin structures (not depicted; alternatively referred to as fins or active regions) formed in the stack, each fin structure protruding from the substrate along a vertical direction. In the present embodiments, the fin structures are configured as the active regions 402, one of which is depicted in FIG. 4A. In some embodiments, the frontside transistors formed at the operation 802 includes a multi-gate transistor, such as a gate-all-around (GAA) or nanosheet transistor, where the active region 402 of the transistor includes the fin structure formed from the stack as described herein. In some embodiments, the frontside transistors formed at the operation 802 include transistors of other configuration(s), such as a CFET, a FinFET, a planar FET, the like, or combinations thereof, as described above.

In some embodiments, the fin structures are formed by patterning the stack (and the substrate) using, for example, photolithography and etching techniques. For example, a mask layer including one or more dielectric layers (e.g., oxide, nitride, etc.) is deposited over the stack and patterned using photolithography techniques. Generally, photolithography techniques utilize a photoresist material (not depicted) that is deposited, irradiated (exposed), and developed to remove a portion of the photoresist material. The remaining photoresist material protects the underlying material, such as the mask layer in this example, from subsequent processing steps, such as etching. The patterned mask is subsequently used to pattern exposed portions of the stack to form trenches (or openings) each disposed between adjacent fin structures. The stack may be etched using, for example, reactive ion etch (RIE), neutral beam etch (NBE), the like, or combinations thereof. The etching process may be anisotropic.

In some examples, the fin structures may be patterned using one or more photolithography processes, including double-patterning or multi-patterning processes. Generally, double-patterning or multi-patterning processes combine photolithography and self-aligned processes, allowing patterns to be created that have, for example, pitches smaller than what is otherwise obtainable using a single, direct photolithography process. For example, in one embodiment, a sacrificial layer is formed over the substrate and patterned using a photolithography process. Spacers are formed alongside the patterned sacrificial layer using a self-aligned process. The sacrificial layer is then removed, and the remaining spacers, or mandrels, may then be used to pattern the fin structures.

Thereafter, isolation regions (not depicted) including a dielectric material are formed over the substrate to electrically isolate neighboring fin structures from each other. The dielectric material may include an oxide, such as silicon oxide, a nitride, a low-k dielectric material, the like, or combinations thereof, and may be formed by a high density plasma chemical vapor deposition (HDP-CVD), a flowable CVD (FCVD) (e.g., a CVD-based material deposition in a remote plasma system and post curing to make it convert to another material, such as an oxide), the like, or combinations thereof. Other insulation materials and/or other formation processes may be used. An anneal process may be performed once the insulation material is formed. The dielectric material may then be planarized and recessed to form the isolation regions.

The method 900 continues to operation 906 during which a number of dummy gate structures (not depicted) are formed over the fin structures in accordance with various embodiments. Such a dummy gate structure may be formed based on one of the (gate structure) patterns. The dummy gate structures generally extend along a direction perpendicular to the lengthwise direction of the fin structures.

The dummy gate structures may be formed by depositing a blanket polysilicon layer over the substrate and fin structures and subsequently patterning the blanket polysilicon layer to form the dummy gate structures. A hard mask may be first deposited, patterned, and subsequently used as an etch mask to pattern the blanket polysilicon layer. Other materials suitable for forming dummy gates can be used while remaining within the scope of present disclosure.

After forming the dummy gate structure, gate spacers (not depicted) may be formed to extend along sidewalls of the dummy gate structure. The gate spacers may be formed by a conformal deposition of a dielectric material including, for example, silicon oxide, silicon nitride, silicon oxynitride, SiBCN, SiOCN, SiOC, the like, or combinations thereof, followed by a directional or anisotropic etching process, such as RIE.

The method 900 proceeds to operation 908 in which inner spacers (not depicted) are formed by replacing end portions of each of the first nanostructures (hereafter referred to as the SiGe sacrificial nanostructures) with a dielectric material in accordance with various embodiments. Upon forming the dummy gate structure overlaying certain portions (e.g., the channel regions 406) of the fin structures, the non-overlaid portions of each fin structure are removed to form source/drain recesses. Next, respective end portions of each SiGe sacrificial nanostructure exposed in the source/drain recesses are removed. The inner spacers are formed by depositing the dielectric material over each recessed SiGe sacrificial nanostructure by suitable deposition process, such as CVD or ALD, and etching the dielectric material to form the inner spacers. The dielectric material of the inner spacers may be the same as or different from that of the gate spacers described above.

The method 900 proceeds to operation 910 during which source/drain structures, such as the source/drain structures 421, 423, and 425, are formed in the source/drain recesses in accordance with various embodiments. Upon forming the inner spacers, the source/drain structures are formed using an epitaxial growth process on the exposed ends of the Si nanostructures in the source/drain recesses. In-situ doping (ISD) may be applied to form doped epitaxial layer(s) in the source/drain structures, thereby creating junctions for a corresponding transistor, such as the first programming transistor 124 and the second programming transistor 126. The epitaxial layer(s) may be doped with an n-type dopant to form an n-type transistor or a p-type dopant to form a p-type transistor. Example dopants of different conductivity types are described above. After forming the source/drain structures, a CESL (not depicted) and an ILD layer (not depicted) are deposited over the source/drain structures and the dummy gate structures. The method 900 proceeds to operation 912 during which the dummy gate structures and the remaining SiGe sacrificial nanostructures are replaced with respective active gate structures, such as the first gate structure 412 and the second gate structure 414 in accordance with various embodiments. Subsequently to forming the ILD layer, the dummy gate structures are removed by an etching process, e.g., RIE or chemical oxide removal (COR). Next, the remaining SiGe sacrificial nanostructures are removed while keeping the Si channel nanostructures (i.e., the second nanostructures) substantially intact by applying a selective etching process (e.g., a hydrochloric acid (HCl)). Next, a number of active gate structures can be formed to wrap around each of the Si channel nanostructures. Each of the active gate structures includes at least a gate dielectric layer (not depicted) and a gate electrode (not depicted) over the gate dielectric layer. In some embodiments, forming the active gate structures completes the fabrication of the frontside transistors, including the first reading transistor 124 and the second reading transistor 126, as a part of the FEOL network of the memory device 400A.

The gate dielectric layer may include any suitable dielectric material, such as silicon oxide, silicon nitride, a high-k dielectric material described above with respect to the gate dielectric layer 18, the like, or combinations thereof. The gate electrode may include at least one work function metal layer and a conductive fill layer over the work function metal layer. The work function metal layer may include TiN, TaN, Ru, Mo, Al, WN, ZrSi₂, MoSi₂, TaSi₂, NiSi₂, Ti, Ag, TaAl, TaAlC, TiAlN, TaC, TaCN, TaSiN, Mn, Zr, the like, or combinations thereof, and the conductive fill layer (or metal fill layer) may include a conductive material similar to that of the gate electrode 16 described above.

Subsequently, referring back to FIG. 10, the method 800 proceeds to operation 804 during which frontside interconnect structures and frontside metallization layers are formed in accordance with various embodiments. The frontside interconnect structures and the frontside metallization layers are coupled to various components of the frontside transistors. Referring to FIG. 4A, for example, the frontside interconnect structures may be configured as components of the MEOL network, such as the MDs (e.g., MDs 422, 424, and 426), the VDs (e.g., VD1 and VD2), and the VGs (e.g., VG1 and VG2). The frontside metallization layers, such as the M0, are configured as a part of the BEOL network and include metal tracks (e.g., the metal tracks 432, 434 and 436) disposed in dielectric layers, such as IMD layers and/or CESLs. In some embodiments, the WLR and the BL of the memory device 400A in FIG. 4A may be formed as metal tracks in one or more of the frontside metallization layers and coupled to the frontside transistors through the frontside interconnect structures described above.

The frontside interconnect structures and the metal tracks in the frontside metallization layers may each be formed in a dielectric layer, such as an IMD layer, and each include a conductive material similar to that of the gate electrode 16 described above. Other conductive materials are within the scope of the present disclosure. The frontside interconnect structures and the frontside metallization layers may be formed by forming and patterning the dielectric layer over the FEOL network, depositing the conductive material over the patterned dielectric layer, and planarizing the conductive material. The planarizing may be implemented by using any suitable method, such as a chemical-mechanical planarization/polishing (CMP) process. The dielectric layer may be patterned using photolithography and etching techniques described above. The conductive material may be deposited by any suitable method, such as CVD, ALD, physical vapor deposition (PVD), electroless plating, electroplating, the like, or combinations thereof. In some embodiments, a barrier layer, a seed layer, or both may be formed over the patterned dielectric layer before depositing the conductive material. The conductive material may be planarized by a CMP process, for example.

The method 800 proceeds to operation 806 during which the substrate 401 is flipped to expose the backside 405 of the substrate 401 opposite to the frontside 403. After flipping the substrate, a polishing process may be performed on the backside 405 of the substrate 401 until a bottom surface of the source/drain structures, such as the source/drain structures 421, 423, and 425, are exposed.

The method 800 proceeds to operation 808 during which backside interconnect structures, such as backside vias and backside source/drain contacts, are formed over the backside 405 in accordance with various embodiments. The backside vias, such as the backside vias 442 and 444, and the backside source/drain contacts (not depicted) are configured to couple the frontside transistors, such as the first reading transistor 124 and the second reading transistor 126, to the backside transistors, such as the first programming transistor 120 and the second programming transistor 122. For example, the backside via 442 couples the source/drain terminal 120s to the source/drain terminal 124d and the backside via 444 couples the source/drain terminal 122s to the source/drain terminal 126d.

The backside vias and the backside source/drain contacts may have a composition similar to that of the frontside interconnect structures and may be formed in a manner similar to that described above with respect to the operation 804. For example, the backside via may be formed by first patterning a dielectric layer formed over the backside of the substrate to form an opening that extends from the backside to the frontside and exposes a backside of a source/drain structure formed on the frontside of the substrate. Subsequently, a conductive material is deposited to fill the opening and planarized by a CMP process, for example, resulting in the backside via.

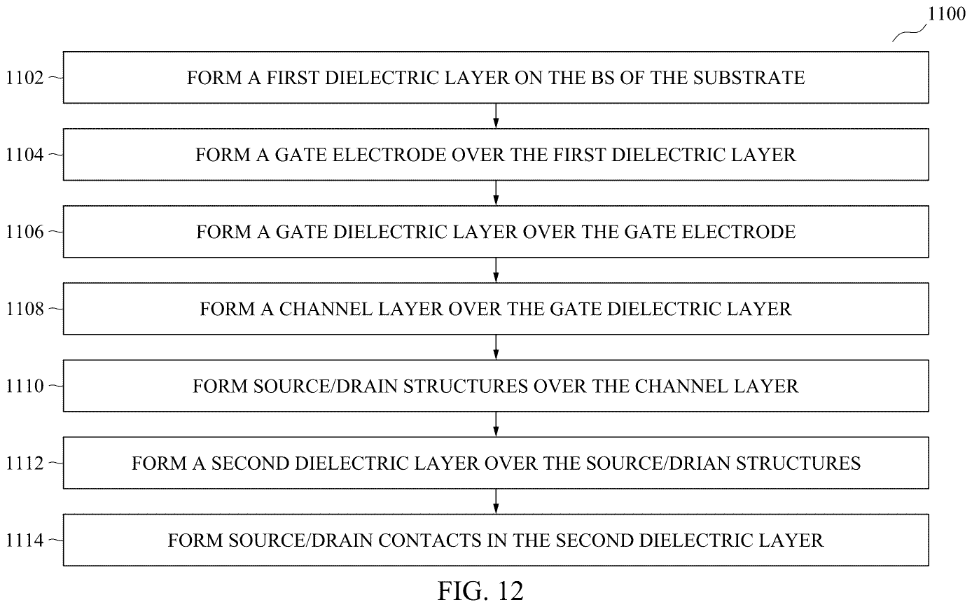

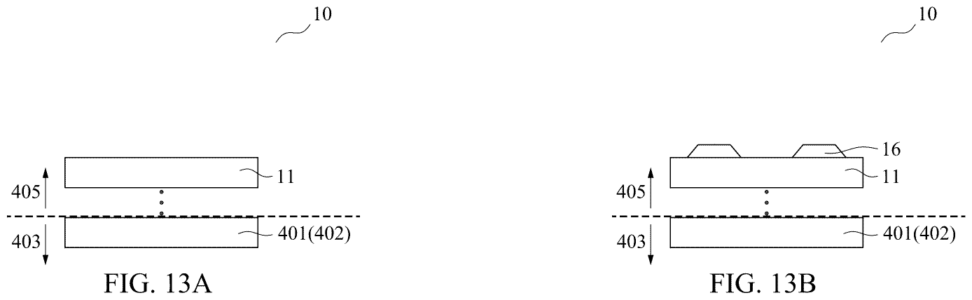

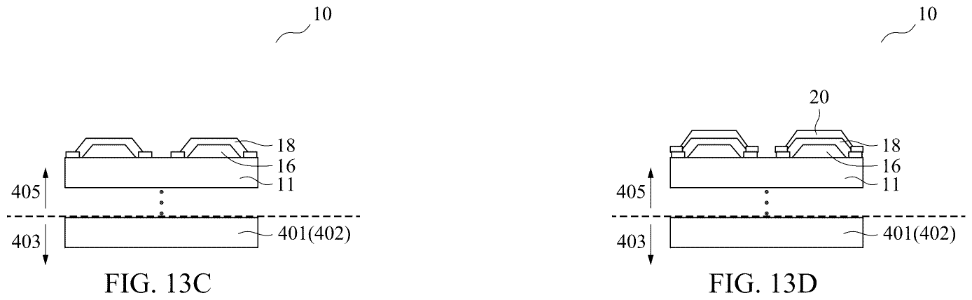

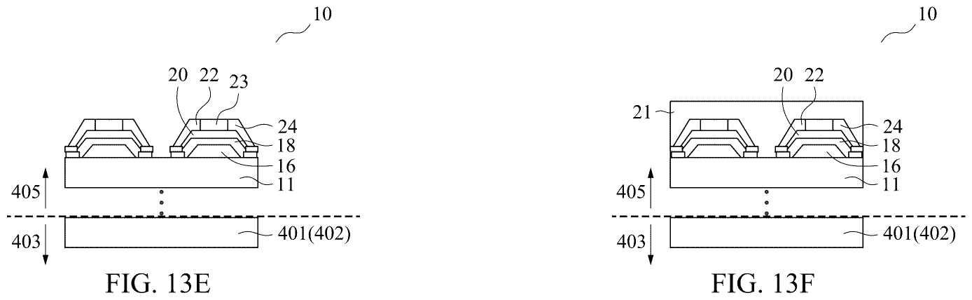

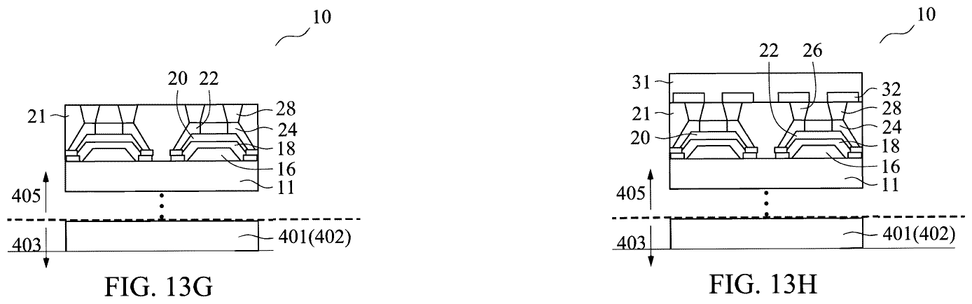

The method 800 proceeds to operation 810 during which one or more backside transistors (alternatively referred to as second transistor), such as the first programming transistor 120 and the second programming transistor 122 as depicted in FIG. 4A, are formed on the backside of the substrate, such as the backside 405 of the substrate 401, and coupled to the backside vias, such as the backside vias 442 and 444 described above. The backside transistors, such as the 2D access transistor 10, may be formed by a method 1100, details of which are described below in reference to operations 1102-1114 of FIG. 12 and FIGS. 13A-13H, which illustrate a series of cross-sectional views of the 2D access transistor 10 during intermediate states of the method 1100. It is noted that the method 1100 is merely an example and is not intended to limit the present disclosure. Accordingly, it is understood that additional operations may be provided before, during, and after the method 1100, and that some other operations may only be briefly described herein. The order of the operations may be interchangeable.

Referring to FIG. 13A, the method 1100 starts with operation 1102 during which a dielectric layer 11 is formed over a backside of a substrate, such as the backside 405 of the substrate 401 in accordance with various embodiments. The dielectric layer 11 may include any suitable material, such as, for example, silicon oxide, silicon nitride, a low-k dielectric material, the like, or combinations thereof. The dielectric layer 11 may be deposited using any suitable method, such as CVD, HDP-CVD, FCVD, the like, or combinations thereof. In some embodiments, the dielectric layer 11 is implemented as an IMD layer in the backside network of the memory device 400A, for example. In this regard, meal tracks (not depicted) may be disposed in the dielectric layer 11. Though not depicted herein, additional dielectric layers and/or metallization layers may be disposed between the backside 405 and the dielectric layer 11 in accordance with some embodiments.

Referring to FIG. 13B, the method 1100 proceeds to operation 1104 during which the gate electrode 16 is formed over the dielectric layer 11 in accordance with various embodiments. In the present embodiments, the gate electrode 16 is formed in proximity to the substrate. The gate electrode 16 may be formed by depositing a blanket metal layer over the dielectric layer 11 and subsequently patterning the blanket metal layer to form the gate electrode 16. The blanket metal layer may be deposited by any suitable method, such as CVD, ALD, PVD, electroless plating, electroplating, the like, or combinations thereof, and patterned by photolithography and etching techniques similar to those described in detail above.

Referring to FIG. 13C, the method 1100 proceeds to operation 1106 during which the gate dielectric layer 18 is formed over the gate electrode 16 in accordance with various embodiments. The gate dielectric layer 18 may be formed by first depositing a blanket dielectric layer over the dielectric layer 11 to enclose the patterned gate electrodes 16 and subsequently patterning the blanket dielectric layer to form the gate dielectric layer 18 extending over each gate electrode 16 as depicted herein. The blanket dielectric layer may be deposited by any suitable method, such as CVD, ALD, PVD, the like, or combinations thereof, and patterned by photolithography and etching techniques similar to those described in detail above.

Referring to FIG. 13D, the method 1100 proceeds to operation 1108 during which the channel layer 20 is formed over the gate dielectric layer 18 in accordance with various embodiments. The channel layer 20 may be formed by first depositing a blanket semiconductor layer over the dielectric layer 11 to enclose the patterned gate dielectric layer 18 and subsequently patterning the blanket semiconductor layer to form the channel layer 20 extending over each gate electrode 16 and gate dielectric layer 18 as depicted herein. The blanket semiconductor layer may be deposited by any suitable method, such as CVD, ALD, PVD, the like, or combinations thereof, and patterned by photolithography and etching techniques similar to those described in detail above.

Referring to FIG. 13E, the method 1100 proceeds to operation 1110 during which the source/drain structures 22 and 24 are formed over the channel layer 20 in accordance with various embodiments. The source/drain structures 22 and 24 may be formed by first depositing a blanket metal layer over the dielectric layer 11 to enclose the patterned channel layer 20 and subsequently patterning the blanket metal layer to form the source/drain structures 22 and 24 separated by an opening 23 as depicted herein. The blanket metal layer may be deposited by any suitable method, such as CVD, ALD, PVD, electroless plating, electroplating, the like, or combinations thereof, and patterned by photolithography and etching techniques similar to those described in detail above.

Referring to FIG. 13F, the method 1100 proceeds to operation 1112 during which the dielectric layer 21 is formed over the source/drain structures 22 and 24 in accordance with various embodiments. The dielectric layer 21 may include any suitable material such as, for example, silicon oxide, silicon nitride, a low-k dielectric material, the like, or combinations thereof. In some embodiments, the dielectric layer 21 has substantially the same composition as the dielectric layer 11. The dielectric layer 21 may be deposited as a blanket layer using any suitable method, such as CVD, HDP-CVD, FCVD, the like, or combinations thereof. In some embodiments, the dielectric layer 21 is implemented as an IMD layer in the backside network. Referring to FIGS. 13G and 13H, the method 1100 proceeds to operation 1114 during which the source/drain contacts 26 and 28 are formed in the dielectric layer 21 and coupled to the source/drain structures 22 and 24, respectively in accordance with various embodiments. The source/drain contacts 26 and 28 may have a composition similar to that of the frontside interconnect structures and may be formed in a manner similar to that described above with respect to the operation 804.

Subsequently, still referring to FIG. 13H, the method 1100 at operation 1114 may further proceed to forming metal tracks 32 in a dielectric layer 31 in accordance with various embodiments. The metal tracks 32 may be formed over and in connection (i.e., coupled) to their respective source/drain contacts (e.g., the source/drain contacts 26 and 28) in a manner similar to that described above with respect to forming the source/drain structures 22 and 24 at operation 1110. For example, a blanket metal layer may be first deposited over the dielectric layer 21 and subsequently patterned to form the metal tracks 32. Thereafter, the dielectric layer 31 is deposited over the metal tracks 32 as a blanket layer in a manner similar to that described above with respect to forming the dielectric layer 21 at operation 1112.

The metal tracks 32 may have a composition similar to that of the frontside interconnect structures. In some embodiments, the metal tracks 32 correspond to the metal tracks 452, 454, and 456 as depicted in FIG. 4A and are thus implemented as a part of the BM0. The metal tracks 32 may have a composition similar to that of the frontside metal tracks described above and may be formed in a manner similar to that described above with respect to the operation 804. The dielectric layer 31 may include any suitable material such as, for example, silicon oxide, silicon nitride, a low-k dielectric material, the like, or combinations thereof. In some embodiments, the dielectric layer 31 has substantially the same composition as the dielectric layer 11. In some embodiments, the dielectric layer 31 is implemented as an IMD layer in the backside network. In some embodiments, the metal tracks 32 and the dielectric layer 31 together comprise one of the backside metallization layer, such as the BM0.

Referring back to FIG. 10, the method 800 proceeds to operation 812 during which additional backside interconnect structures and backside metallization layers are formed over and coupled to the backside transistors in accordance with various embodiments. For example, additional backside interconnect structures (not depicted) similar to the source/drain contacts 26 and 28, as well as metal tracks similar to the metal tracks 32 are formed on the backside 405. The backside interconnect structures and the backside metallization layers may have compositions similar to those of the frontside interconnect structures and the frontside metallization layers and may be formed in a manner similar to that described above with respect to the operation 804.

In some aspects, the present disclosure relates to a memory device, including: a substrate and a memory cell. The substrate includes a frontside and a backside opposite to the frontside. The memory cell includes a programming transistor, a reading transistor, and a backside via. The programming transistor is disposed on a first one of the frontside or the backside of the substrate. The reading transistor is disposed a second one of the frontside or the backside of the substrate opposite to the programming transistor. The backside via extends from the backside to the frontside of the substrate, thereby coupling the programming transistor to the reading transistor in series.

In some aspects, the present disclosure relates to a memory device, including: a substrate and a memory cell. The memory cell includes a first programming transistor, a first reading transistor, a second reading transistor, a first via, and a second via. The first programming transistor is disposed on a first surface of the substrate. The first reading transistor and the second reading transistor are disposed on a second surface of the substrate opposite to the first surface. The first programming transistor is coupled in series between the first reading transistor and the second reading transistor through the first via and the second via, respectively.

In some aspects, the present disclosure relates to a method of fabricating a semiconductor device. The method includes forming a first transistor on a frontside of a substrate. The method includes forming first interconnect structures on the frontside. The method includes flipping the substrate to expose a backside of the substrate opposite to the frontside. The method includes forming a backside via extending from the backside to the frontside and coupled to the first transistor. The method includes forming a second transistor coupled to the backside via on the backside such that the second transistor is coupled to the first transistor in series through the backside via. The method includes forming backside metallization layer coupled to the second transistor on the backside.

As used herein, the terms “about” and “approximately” generally mean plus or minus 10% of the stated value. For example, about 0.5 would include 0.45 and 0.55, about 10 would include 9 to 11, about 1000 would include 900 to 1100.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A memory device, comprising:
a substrate including a frontside and a backside opposite to the frontside; and
a memory cell including a programming transistor, a reading transistor, and a backside via, wherein:
the programming transistor is disposed on a first one of the frontside or the backside of the substrate,
the reading transistor is disposed on a second one of the frontside or the backside of the substrate opposite to the programming transistor, and
the backside via extends from the backside to the frontside of the substrate, thereby coupling the programming transistor to the reading transistor in series.

2. The memory device of claim 1, wherein:
the memory device includes a metal track disposed on the backside of the substrate, and
the metal track is coupled between the backside via and one of the reading transistor or the programming transistor.

3. The memory device of claim 1, wherein:
the programming transistor is a first programming transistor, and
the memory cell further includes a second programming transistor disposed on the first one of the frontside or the backside of the substrate.

4. The memory device of claim 3, wherein the first programming transistor and the second programming transistor are commonly gated by a programming word line.

5. The memory device of claim 3, wherein the first programming transistor and the second programming transistor are respectively gated by a first programming word line and a second programming word line.

6. The memory device of claim 1, wherein:
the reading transistor is a first reading transistor,
the memory cell further includes a second reading transistor disposed on the second one of the frontside or the backside of the substrate, and
the first reading transistor and the second reading transistor are commonly coupled to a bit line.

7. The memory device of claim 6, wherein the first reading transistor and the second reading transistor are commonly gated by a reading word line.

8. The memory device of claim 6, wherein the first reading transistor and the second reading transistor are respectively gated by a first reading word line and a second reading word line.

9. The memory device of claim 6, wherein:
the first reading transistor and the second reading transistor are disposed on the frontside of the substrate,
the backside via is a first backside via,
the memory cell further includes a second backside via, and
the programming transistor is coupled in series to the first reading transistor and the second reading transistor through the first backside via and the second backside via, respectively.

10. A memory device, comprising:
a substrate; and
a memory cell including a first programming transistor, a first reading transistor, a second reading transistor, a first via, and a second via, wherein:
the first programming transistor is disposed on a first surface of the substrate,
the first reading transistor and the second reading transistor are disposed on a second surface of the substrate opposite to the first surface, and
the first programming transistor is coupled in series between the first reading transistor and the second reading transistor through the first via and the second via, respectively.

11. The memory device of claim 10, wherein:
the memory device further includes a second programming transistor disposed on the first surface of the substrate and coupled in series between the first programming transistor and one of the first reading transistor or the second reading transistor, and
the second programming transistor is coupled to the second via.

12. The memory device of claim 11, wherein the first programming transistor and the second programming transistor are commonly coupled and floating.

13. The memory device of claim 11, wherein:
the first programming transistor includes a first gate dielectric layer,
the second programming transistor includes a second gate dielectric layer, and
either the first gate dielectric layer or the second gate dielectric layer is configured to be randomly broken down to present a first logic state or a second logic state.

14. The memory device of claim 10, wherein:
the first programming transistor includes a gate dielectric layer having a first dielectric portion and a second dielectric portion, and
either the first dielectric portion or the second dielectric portion is configured to be randomly broken down to present a first logic state or a second logic state.

15. The memory device of claim 10, wherein the first reading transistor and the second reading transistor are commonly coupled to a bit line.

16. The memory device of claim 10, wherein the first reading transistor and the second reading transistor are respectively coupled a first bit line and a second bit line.

17. A method of fabricating a semiconductor device, comprising:
forming a first transistor on a frontside of a substrate;
forming first interconnect structures on the frontside;
flipping the substrate to expose a backside of the substrate opposite to the frontside;
forming a backside via extending from the backside to the frontside and coupled to the first transistor;
forming a second transistor coupled to the backside via on the backside such that the second transistor is coupled to the first transistor in series through the backside via; and
forming a backside metallization layer coupled to the second transistor on the backside.

18. The method of claim 17, wherein:
the first transistor is a reading transistor of a memory cell,
the second transistor is a programming transistor of the memory cell, and
the memory cell is an anti-fuse cell configured to present either a first logic state or a second logic state.

19. The method of claim 17, wherein:
the first transistor is a programming transistor of a memory cell,
the second transistor is a reading transistor of the memory cell, and
the memory cell is an anti-fuse cell configured to present either a first logic state or a second logic state.

20. The method of claim 17, wherein forming the second transistor includes:
forming a first dielectric layer on the backside,
forming a gate electrode on the first dielectric layer,
forming a gate dielectric layer over the gate electrode,
forming a channel layer over the gate dielectric layer, the channel layer including a metal-containing semiconductor material, and
forming a pair of source/drain structures on the channel layer.
